(19) United States
(12) Patent Application Publication
(10) Pub. No.: US 2025/0348085 A1
(43) Pub. Date: Nov. 13, 2025

(54) VEHICLE-MOUNTED, HUMAN-LIKE, MOBILE SECURITY ROBOT

(71) Applicants: Ching-Tien Ho, San Jose, CA (US); Theodore Li, San Jose, CA (US); David Fong, Sunnyvale, CA (US)

(72) Inventors: Ching-Tien Ho, San Jose, CA (US); Theodore Li, San Jose, CA (US); David Fong, Sunnyvale, CA (US)

(21) Appl. No.: 18/661,714

(22) Filed: May 13, 2024

(51) Int. Cl. G05D 1/648; G05D 1/622; G05D 1/646; G05D 1/65; G05D 101/15; G05D 105/55; G05D 105/70; G05D 105/85; G05D 109/10; G05D 111/10; G05D 111/20; G05D 111/30; G05D 111/50

(52) U.S. Cl. CPC G05D 1/648; G05D 1/622; G05D 1/646; G05D 1/65; G05D 2101/15; G05D 2105/55; G05D 2105/70; G05D 2105/85; G05D 2109/10; G05D 2111/10; G05D 2111/20; G05D 2111/32; G05D 2111/52

(57) ABSTRACT

A mobile security robot includes a human-sized mannequin mounted on a vehicle. A storage unit, mounted on the vehicle, stores security devices and high-powered energy storage devices for facilitating extended patrols without recharge. A video recording system, disposed in the mannequin, continuously records images of a patrol area. Multiple sensors mounted on and proximal to the mannequin generate sensor data based on environmental conditions of the patrol area. A computing system coupled to the sensors processes the sensor data using artificial intelligence models and generates action commands for execution of tasks by actuators including electric motors, robotic arms, and supplementary attachment devices. The electric motors run the vehicle at different speeds with wheel speed feedback based on the environmental conditions and navigate the vehicle along a predefined travel path with object avoidance during patrols. User interface devices facilitate auditory and visual communication with humans in the patrol area.

### CROSS-REFERENCE TO RELATED APPLICATIONS

This application is a continuation-in-part (CIP) application of the non-provisional patent application titled “Mobile, Human-like Security Guard Mannequin Robot Mounted On An Autonomous Electric Vehicle”, application Ser. No. 18/478,974, filed in the United States Patent and Trademark Office on Sep. 29, 2023, which claims priority to and the benefit of the provisional patent application titled “A Large Mobile Security Robot Using A Large, Human-like Security Guard Mannequin Mounted On An Autonomous Electric Vehicle”, application No. 63/411,154, filed in the United States Patent and Trademark Office on Sep. 29, 2022. The specifications of the above-referenced patent applications are incorporated herein by reference in their entirety.

### BACKGROUND

Most common crimes in the United States of America (USA) relate to property, theft, larceny, burglary, vehicle theft, and physical assault, which typically occur in parking lots, affluent residential communities, shopping malls, etc. Typically, an offender or a perpetrator is antisocial and does not wish to draw public attention. The offender typically commits a crime, for example, a theft, in the absence of an owner of a property, or attacks a victim when the victim is alone. Such thefts and attacks may be avoided by having police or security personnel regularly patrol the property or other areas, for example, parking lots, affluent residential communities, shopping malls, etc. However, police or security personnel, being human beings, tend to get tired, feel sleepy or lethargic, get sick, need breaks, etc., and therefore, may not be able to continuously patrol the property without interruption. To overcome the limitations associated with human fatigue, the use of security robots by security establishments worldwide has emerged. However, conventional security robots are not human-shaped and do not provide the same level of deterrence as human security personnel. Most often, conventional security robots are toy-shaped and travel at low speeds with small motors and low battery capacities.

Most conventional mechanical security robots used for patrolling an area are small in size, for example, about 2 feet in height, and travel at slow speeds, for example, from about 2 miles per hour (mph) to about 5 mph. These mechanical security robots do not include a human-like mannequin in uniform and have no tricolor flashing lights to intimidate perpetrators. Moreover, these mechanical security robots have low battery capacities, thereby requiring frequent recharges during a patrol. Furthermore, these mechanical security robots have small wheels that move the mechanical security robots, for example, from about 2 mph to about 5 mph. Furthermore, the plain body color of these mechanical security robots does not psychologically intimidate offenders. Other conventional security robots include pipe-shaped robots used for underground excavation, pipe cleaning, and tunnel engineering. Furthermore, other conventional security robots and science robots are roly-poly, toy-shaped or tumbler-shaped without any human-like element or shape. Another example of a conventional security robot is a four-legged robot dog used for trotting around an area, mapping and inspecting its environment, climbing stairs, opening doors, and fighting in battle fields. The four-legged robot dog is shaped like an animal, not a human. Four-legged robot dogs are mostly remote controlled by a human operator and are not designed to operate in an urban environment.

The above-disclosed conventional security robots either do not include a human-like mannequin element or are standalone units that are not mounted on a moving electrical vehicle. Moreover, these conventional security robots, due to their designs, cannot carry a substantial amount of payload and cannot patrol an urban area with variable speeds on urban roads. Furthermore, these conventional security robots are small in size, for example, about 1 feet×1.5 feet×1.5 feet, have low battery power of, for example, about 4 volts (V) in voltage, requiring frequent recharges, operate without a uniformed, human-sized-mannequin, and are not adorned with attention-grabbing, authoritative elements.

Hence, there is a long-felt need for a vehicle-mounted, human-like, mobile security robot comprising a human-sized mannequin mounted on a vehicle, for example, an autonomous electric vehicle or a piston-operated vehicle, that is capable of patrolling areas in challenging conditions continuously, without interruption and with variable speeds; carrying substantial payload; and identifying suspicious humans and irregular activities in the patrol area, thereby protecting the patrol area from potential security and safety threats, while addressing the above-recited problems associated with the related art.

### SUMMARY OF THE INVENTION

This summary is provided to introduce a selection of concepts in a simplified form that are further disclosed in the detailed description of the invention. This summary is not intended to determine the scope of the claimed subject matter.

The system disclosed herein addresses the above-recited need for a vehicle-mounted, human-like, mobile security robot comprising a human-sized mannequin mounted on a vehicle, for example, an autonomous electric vehicle or a piston-operated vehicle, that is capable of patrolling areas in challenging conditions continuously, without interruption and with variable speeds; carrying substantial payload; and identifying suspicious humans and irregular activities in the patrol area, thereby protecting the patrol area from potential security and safety threats. The mobile security robot is configured to carry out an autonomous security patrol with a flashing light and a loudspeaker included on top of the mobile security robot to draw more public attention on irregular events in an assigned patrol area, to deter crimes while video and audio recording its patrol path. The mobile security robot equipped with a large human-sized mannequin is configured to be similar to a law enforcement agent, for example, a security guard, a police person, and other security personnel, mounted on a vehicle, clothed in a bright, eye-catching uniform to conduct security patrols with flashing lights, video recording abilities, loudspeakers, and other intimidating devices to scare off perpetrators, for example, car thieves, derelicts, vagabonds, fugitives, etc. The mobile security robot is configured to observe, assist, and prevent crimes in patrol areas, for example, private residences, businesses, public parks, etc., and to work with the police to lower crime rates.

The mobile security robot disclosed herein comprises a vehicle, a storage unit, a human-sized mannequin, a video recording system, multiple sensors, a computing system, multiple actuators, multiple user interface devices, and multiple output devices. The vehicle comprises a chassis, a drive subsystem, and wheels. In an embodiment, the vehicle is an autonomous electric vehicle. In another embodiment, the vehicle is a piston-operated vehicle. In an example, the vehicle is about 5 feet in length and about 4 feet in width, equipped with 21-inch tires. The storage unit is mounted on the chassis of the vehicle. The storage unit is configured to store multiple security devices and multiple high-powered energy storage devices, for example, high-powered batteries, for facilitating extended patrols without recharge. The security devices stored in the storage unit comprise, for example, robotic arms, heat sensors, radioactive sensors, medical equipment, emergency devices, fire extinguishers, weapons such as rifles, wielding guns, water guns, etc., bullet-proof shields, protective covers, supply devices, repair devices, and supplementary robots. The human-sized mannequin is mounted on the vehicle in a seated position, proximal to the storage unit. In an embodiment, the human-sized mannequin is mounted in front of the storage unit on the vehicle. The human-sized mannequin is configured to resemble a human being comprising a movable head with a face, nose, eyes, and a mouth, and a rotatable torso. In an example, the torso is about 3 feet high to about 4 feet high. Furthermore, the torso is rotatable, for example, from about 45 degrees to about 90 degrees. In an embodiment, the human-sized mannequin is dressed in a security uniform comprising, for example, a shirt, a security badge, and headgear in attention-grabbing colors representing authority and intimidation to humans in the patrol area.

The video recording system of the mobile security robot is disposed in the human-sized mannequin, for example, on the neck of the human-sized mannequin. The video recording system is configured to continuously record images of a patrol area. The sensors of the mobile security robot are mounted on and proximal to the human-sized mannequin. The sensors are configured to detect and capture environmental conditions of the patrol area and generate sensor data comprising, for example, audio data, audiovisual data, light data, tactile data, image data, video data, and environmental data of the patrol area. The sensors comprise, for example, red, green, and blue (RGB) cameras, thermal cameras, infrared cameras, stereo depth cameras, microphone arrays, light detection and ranging (LiDAR) 126a devices, ultrasonic sensors, a global positioning system (GPS), inertial measurement units (IMUs), temperature sensors, humidity sensors, air pressure sensors, gas detection devices, and multiple Hall effect sensors. In an embodiment, the mobile security robot is configured to have a low center of gravity. In an embodiment, the mobile security robot further comprises a support frame constituted by at least two triangle-poles disposed behind the human-sized mannequin on the vehicle. The support frame is configured to support the human-sized mannequin and preclude the mobile security robot from being overturned and damaged due to the low center of gravity design of the mobile security robot. In an embodiment, three-dimensional (3D) cameras are disposed on the support frame above the human-sized mannequin. The 3D cameras are configured to capture images of surrounding activities in the patrol area.

The computing system of the mobile security robot is operably coupled to the sensors. The computing system comprises at least one processor, a memory unit operably and communicatively coupled to the processor(s), and a robot control module. The memory unit is configured to store computer program instructions, which when executed by the processor(s), cause the processor(s) to: receive the sensor data from the sensors; process the received sensor data using a plurality of artificial intelligence (AI) models, and based on the processing of the received sensor data, generate action commands for execution of multiple tasks by the actuators. In an embodiment, the processing of the received sensor data comprises processing audio data to interpret human speech and respond to verbal requests of the humans in the patrol area by executing voice recognition and natural language processing algorithms. In another embodiment, the processing of the received sensor data comprises processing image data to detect and identify multiple environmental objects in the patrol area using positioning algorithms, point cloud libraries, and one or more of the sensors; facilitate navigation of the vehicle away from or toward the detected environmental objects; detect a fire using the image data in combination with temperature data received from temperature sensors operating with cameras on the human-sized mannequin; detect and digitize human poses in the image data using pose AI analysis for identifying suspicious humans and irregular activities in the patrol area; and perform advanced object tracking using computer vision algorithms. In another embodiment, the processing of the received sensor data comprises processing audio data to follow-up with the identified suspicious humans and the irregular activities in the patrol area using generative AI along with the audio data received from the microphone arrays mounted on the human-sized mannequin. The AI models executed for processing the received sensor data comprise, for example, a large language model (LLM), a local large multimodal model (LMM), a cloud-based LMM, and a deep neural network (DNN) model. In an embodiment, the memory unit is configured to store computer program instructions, which when executed by the processor(s), cause the processor(s) to generate feedback for adjusting the AI models for future processing.

The robot control module is operably coupled to the processor(s) and is configured to control the actuators based on the generated action commands. In an embodiment, the computing system further comprises a communication module operably coupled to the processor(s) and to multiple supplementary robots and control stations via a cloud server. The supplementary robots comprise, for example, small robots, drones, etc. The supplementary robots are carried within the storage unit and transported to a target area by the vehicle. In an embodiment, the supplementary robots are recharged using the high-powered energy storage devices in the storage unit and diagnosed, debugged, and repaired using the computing system. The communication module is configured to upload and download data streams for processing, storage, and communications. In an embodiment, the computing system further comprises a battery and power management module operably coupled to the processor(s) and configured to provide a sustained power source to the mobile security robot and manage power consumption based on task priority.

The actuators of the mobile security robot are operably coupled to the robot control module of the computing system. The actuators comprises electric motors, robotic arms, and multiple supplementary attachment devices. The electric motors are configured to run the vehicle at multiple predetermined speeds with wheel speed feedback based on the environmental conditions. The predetermined speeds range, for example, from about 3 miles per hour (mph) to about 50 mph or about 100 mph. The electric motors are further configured to navigate the vehicle along a predefined travel path with object avoidance using route maps and a robot operating system (ROS) navigation stack, during patrols in the patrol area. In an embodiment, the Hall effect sensors are configured to provide the wheel speed feedback for adjusting the predetermined speeds to run the vehicle. In an embodiment, the robot control module of the computing system, in communication with the electric motors in the drive subsystem of the vehicle, is configured to control the speed of the vehicle using pulse-width modulation technology with regenerative braking.

The robotic arms are configured to carry out one or more of multiple tasks in the patrol area. The supplementary attachment devices comprise security devices, for example, wielding guns, water guns, etc., configured to carry out one or more of multiple tasks in the patrol area. The tasks comprise, for example: shooting a colored fluid towards unlawful elements; holding a striking tool such as a hammer, a baton, etc., to break barriers for inspection; providing shields for protection from bullets and shrapnel; offloading supplementary robots to a target patrol area to perform another one or more of the plurality of tasks; holding a water hose to one of extinguish a fire and solder metals in a shipyard; etc.

The user interface devices of the mobile security robot are operably coupled to the computing system. The user interface devices are configured to facilitate auditory and visual communication with humans in the patrol area. In an embodiment, the user interface devices comprise speakers configured to communicate with humans in the patrol area. In another embodiment, the user interface devices comprise one or more display panels connected to a front side of the vehicle for facilitating communication between the humans in the patrol area and the control stations. The output devices of the mobile security robot comprise loudspeakers and/or flashing light devices operably coupled to the computing system. The loudspeakers and/or flashing light devices are configured to convey alerts and warnings in the patrol area. In an embodiment, the loudspeakers and the flashing light devices are disposed on a top side of the support frame above the human-sized mannequin.

In an embodiment, the mobile security robot is configured to transform itself into another physical machine using one or more of the actuators, for example, the robotic arms, the security devices, etc., to perform supplementary functions for protection, safety, and defence.

In one or more embodiments, related systems comprise circuitry and/or programming for executing the methods disclosed herein. The circuitry and/or programming comprise one or any combination of hardware, software, and/or firmware configured to execute the methods disclosed herein depending upon the design choices of a system designer. In an embodiment, various structural elements are employed depending on the design choices of the system designer.

### BRIEF DESCRIPTION OF THE DRAWINGS

The foregoing summary, as well as the following detailed description of the invention, is better understood when read in conjunction with the appended drawings. For illustrating the embodiments herein, exemplary constructions of the embodiments are shown in the drawings. However, the embodiments herein are not limited to the specific components, structures, and methods disclosed herein. The description of a component, or a structure, or a method step referenced by a numeral in a drawing is applicable to the description of that component, or structure, or method step shown by that same numeral in any subsequent drawing herein. The terms “front”, “rear”, “side”, “top”, “bottom”, “upper”, “lower”, “inner”, “outer”, etc., are based on an orientation or a positional relationship shown in the appended drawings, and are recited merely for describing the embodiments herein, rather than indicating or implying that the device, component, or structure referenced must have a particular orientation or position or must be constructed and operated in a particular orientation, and therefore should not be construed as limiting the embodiments herein.

FIG. 1A illustrates a front elevation view of an embodiment of a vehicle-mounted, human-like, mobile security robot.

FIG. 1B illustrates a rear elevation view of the embodiment of the vehicle-mounted, human-like, mobile security robot shown in FIG. 1A.

FIG. 1C illustrates a left-side elevation view of the embodiment of the vehicle-mounted, human-like, mobile security robot shown in FIG. 1A.

FIG. 1D illustrates a right-side elevation view of the embodiment of the vehicle-mounted, human-like, mobile security robot shown in FIG. 1A.

FIG. 1E illustrates a top plan view of the embodiment of the vehicle-mounted, human-like, mobile security robot shown in FIG. 1A.

FIG. 1F illustrates a bottom elevation view of the embodiment of the vehicle-mounted, human-like, mobile security robot shown in FIG. 1A.

FIG. 2 illustrates an exploded, perspective view of the embodiment of the vehicle-mounted, human-like, mobile security robot shown in FIG. 1A.

FIGS. 3A-3B illustrate perspective views of embodiments of a chassis of a vehicle configured to mount a human-sized mannequin thereon.

FIG. 4 illustrates a front elevation view of an embodiment of the vehicle-mounted, human-like, mobile security robot comprising robotic arms.

FIG. 5 illustrates an architectural block diagram of an embodiment of a hardware implementation of the vehicle-mounted, human-like, mobile security robot.

FIG. 6 illustrates a flowchart of an embodiment of a software implementation of the vehicle-mounted, human-like, mobile security robot.

FIG. 7A illustrates a three-dimensional navigation cloud map utilized by the vehicle-mounted, human-like, mobile security robot for navigating a patrol area.

FIGS. 7B-7C illustrate grid robot operating system (ROS) navigation maps utilized by the vehicle-mounted, human-like, mobile security robot for navigating a patrol area.

FIG. 7D illustrates a cost map utilized by the vehicle-mounted, human-like, mobile security robot for object avoidance during a patrol.

FIGS. 8A-8B illustrate bottom elevation views showing movement and object avoidance of an embodiment of the vehicle-mounted, human-like, mobile security robot.

### DETAILED DESCRIPTION OF THE INVENTION

Various aspects of the disclosure herein are embodied as a system, a method, or a non-transitory, computer-readable storage medium having one or more computer-readable program codes stored thereon. Accordingly, various embodiments of the disclosure herein take the form of an entirely hardware embodiment, an entirely software embodiment comprising, for example, microcode, firmware, software, etc., or an embodiment combining software and hardware aspects that are referred to herein as a “system”, a “module”, an “engine”, a “circuit”, or a “unit”.

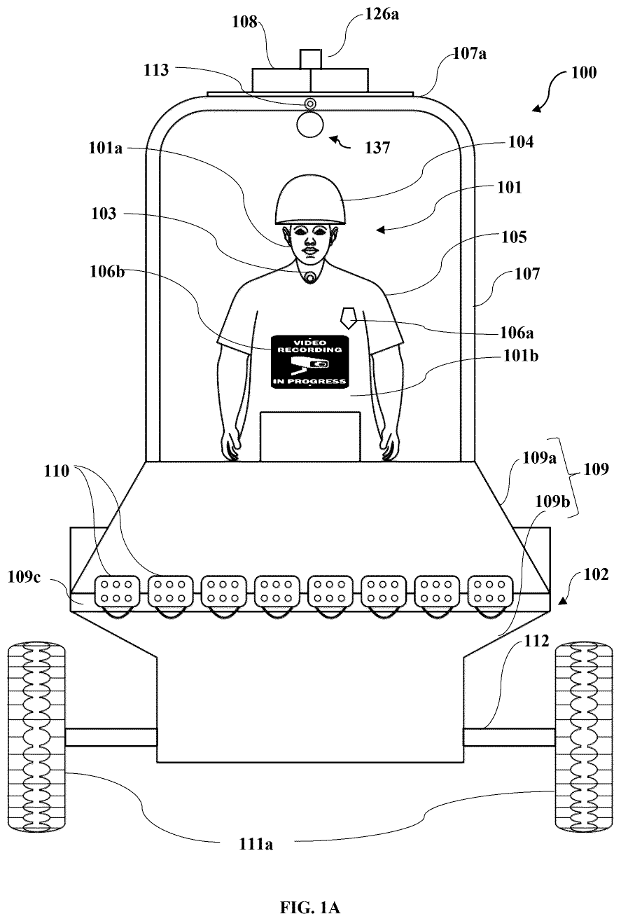

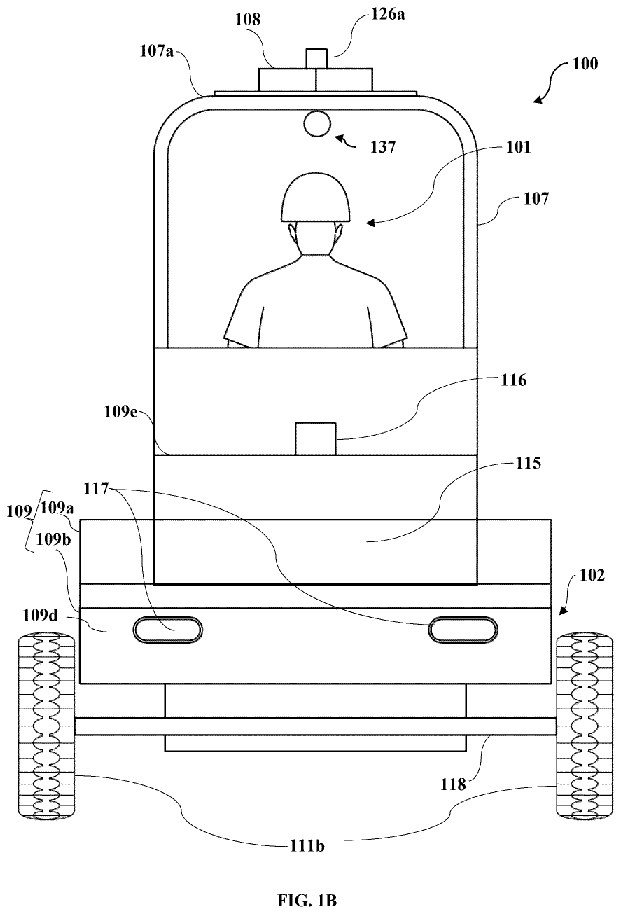

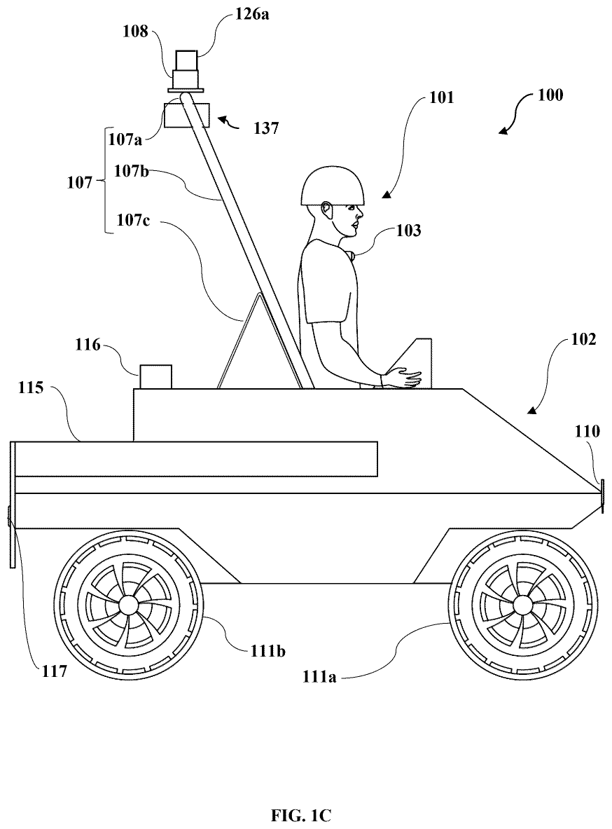

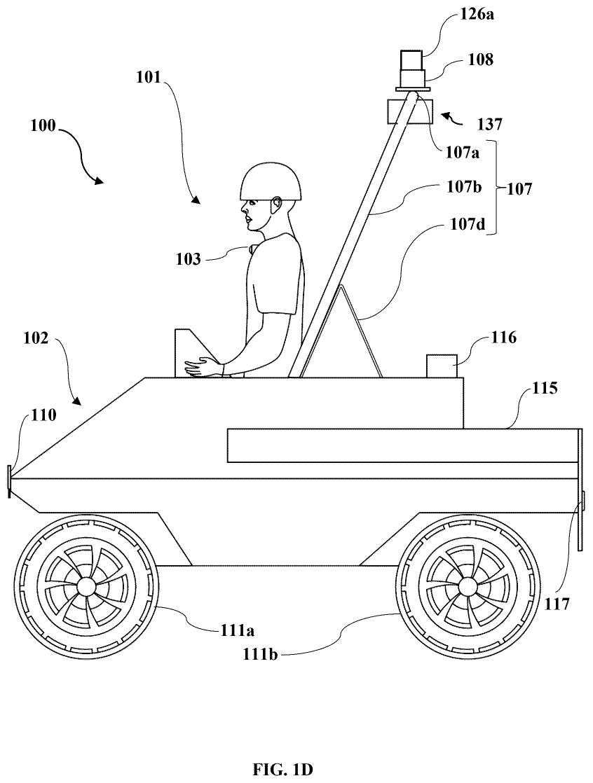

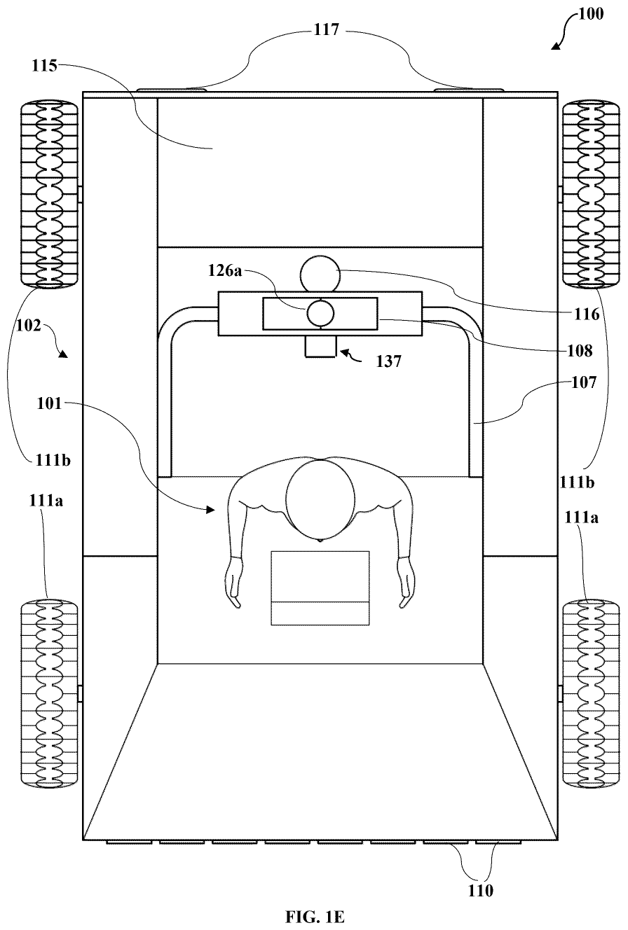

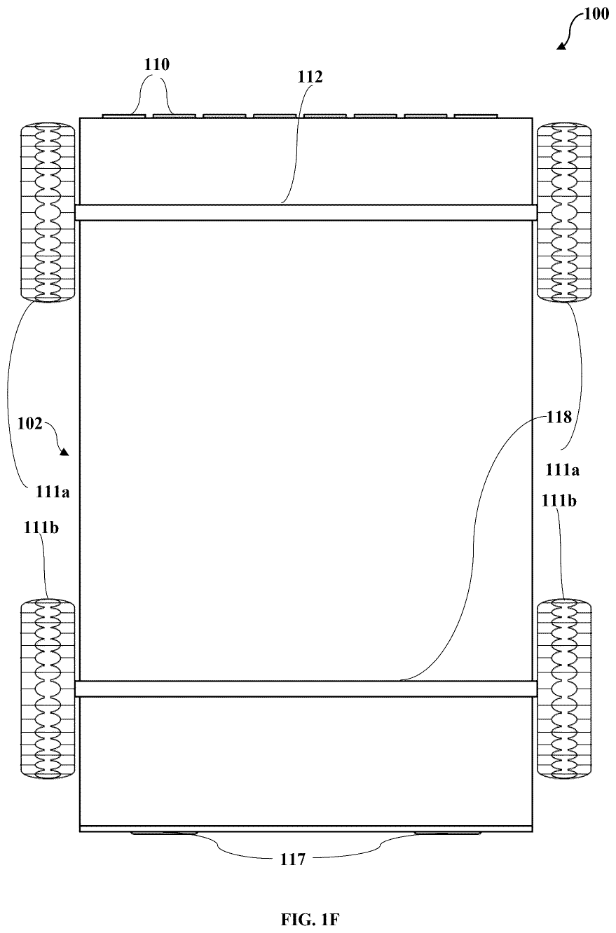

FIGS. 1A-1F illustrate a front elevation view, a rear elevation view, a left-side elevation view, a right-side elevation view, a top plan view, and a bottom elevation view, respectively, of a vehicle-mounted, human-like, mobile security robot 100. The vehicle-mounted, human-like, mobile security robot 100, herein referred to as a “mobile security robot”, is a large, human-sized, security guard-like, mannequin 101 in uniform mounted on a vehicle 102, for example, an autonomous vehicle 102, with electrics and artificial intelligence (AI) software, configured to conduct security patrols and intimate perpetrators due to its large size to deter crimes and perform multiple related applications, while offering assistance to the public. The mobile security robot 100 is an electrical robot configured as a large intimidating robot, for example, a police-like robot, to perform autonomous security patrols for an extended period of time, for example, 24 hours a day, 7 days a week, while video and audio recording its patrol path with one or more flashing lights 108 to deter crimes. In an embodiment, the patrol path comprises, for example, private roads, private premises, exempted roads, and/or exempted lands that do not require stringent government safety registrations.

The mobile security robot 100 is configured to operate in patrol areas, for example, private premises, private roads, private residences, businesses, public parks, airports, forest parks, borders, urban roads, suburban paved roads, etc., with a warning sign 106b reciting “video-recording-in-progress”, to warn perpetrators off. Together with the “video-recording-in-progress” warning sign, the mobile security robot 100 warns off an offender, derelict, vagrant, etc., from patrol areas, for example, residential communities, commercial parking lots, office parks, shopping malls, etc. In an embodiment, the mobile security robot 100, when operating on private land or private roads, does not require a government license, for example, a license from the Department of Motor Vehicles (DMV), or require a DMV registration, and is exempted from meeting stringent safety standards, for example, Society of Automotive Engineers (SAE) safety standards. The mobile security robot 100 is configured to patrol, for example, privately owned roads comprising parking lots, shopping malls, private residential communities, where the mobile security robot 100 can be easily deployed without government registrations.

In an embodiment, the mobile security robot 100 comprises a vehicle 102, for example, a moving, electrical vehicle (EV), equipped with sensors configured to capture environmental conditions of a patrol area, for example, landmarks, waypoints, longitude, latitude, directions, images of objects, sound, etc., and send associated sensor data to a computing system of the mobile security robot 100 for generating predetermined actions on physical devices of the mobile security robot 100 comprising, for example, flashing lights 108, loudspeakers 137, wheels 111a and 111b, etc., to scare off perpetrators from committing a crime. In an embodiment, the mobile security robot 100 is configured to have a low center of gravity. In an example, the dimensions of the mobile security robot 100 is, for example, more than about 6 feet×4 feet×5 feet, similar to a passenger car, for example, a 4-seater hatchback car. The size of the mobile security robot 100 is configured to allow carrying of multiple devices, for example, mechanical devices such as robotic arms, humans such as police officers, weapons, fire extinguishers, steel shields for protecting humans, medical equipment for emergency aides, sensors such as radioactive sensors, heat sensors, etc., thereon, to expand the tasks of the mobile security robot 100 during a patrol. The large-sized mobile security robot 100, smaller than a truck, is agile and can easily make turns in a short distance to respond to people's needs. In an embodiment, the size of the mobile security robot 100 can be increased to accommodate additional devices and technology.

As illustrated in FIGS. 1A-1E, the mobile security robot 100 disclosed herein comprises a human-sized mannequin 101 mounted on a vehicle 102. In an embodiment, the human-sized mannequin 101 is a large, human-like, security guard mannequin 101 mounted on a vehicle 102, for example, an autonomous vehicle such as a multi-wheel, self-driving electric vehicle, configured to patrol various patrol areas, for example, private roads, exempted roads, parking lots, private office parks, etc., and intimidate perpetrators to deter crimes in different locations, for example, real estate communities, office buildings, etc. The electric vehicle is a vehicle that is electrically powered, for example, by direct current (DC) batteries and controlled by autonomous drive technology. The human-sized mannequin 101 is mounted on the vehicle 102 in a seated position as illustrated in FIGS. 1A-1E. The human-sized mannequin 101 is configured to resemble a human being comprising a movable head 101a with a face, nose, visible eyes, and a mouth, and a rotatable torso 101b. In an example, the face is made of human-sized mannequin 101 is made of polymeric materials for cost savings. In an example, the torso 101b is about 3 feet high to about 4 feet high. Furthermore, the torso 101b is rotatable, for example, from about 45 degrees to about 90 degrees. In an embodiment, the human-sized mannequin 101 is a humanoid configured to replicate human movements and functions automatically. In an embodiment, the human-sized mannequin 101 is dressed in a security uniform comprising, for example, a shirt 105, a security badge 106a or a security marking, and headgear 104 such as a helmet or a police hat, in attention-grabbing colors representing authority and intimidation to humans, for example, perpetrators, in the patrol area.

In an embodiment, the human-sized mannequin 101 is configured be similar to a law enforcement agent, for example, a security guard, mounted on a vehicle 102, clothed in a bright, eye-catching uniform, for example, a security guard uniform, a police uniform, etc., in bolt eye-catching colors such as blue and yellow, with a security badge 106a and a white helmet, to conduct security patrols with flashing lights 108, video recording abilities, loudspeakers 137, and other intimidating devices to scare off perpetrators, for example, car thieves, derelicts, vagabonds, fugitives, etc., to deter crimes. In another embodiment, a warning sign 106b is disposed on the shirt 105 of the human-sized mannequin 101 to notify and warn perpetrators about video recording and surveillance being performed. The attire or apparel of the human-sized mannequin 101 is configured to attract attention and present authority to the public, providing more psychological effects to scare off perpetrators. In an embodiment, the body of the human-sized mannequin 101 is painted in bolt red, blue, and yellow colors with a flashing light, to attract attention of the public, to chase away perpetrators and warn off children.

In an embodiment, the human-sized mannequin 101 is equipped with sensors comprising, for example, cameras, micro-speakers, lights, etc. In an embodiment, a series of sensors is mounted on the human-sized mannequin 101 and/or the vehicle 102 to detect environmental conditions which are then processed by one or more processors, for example, microprocessors, using algorithms supported by AI models along with a robot operating system (ROS) navigation stack, a global positioning system (GPS) receiver capable of real time kinematics (RTK), inertial measurement units, cameras, light detection and ranging (LIDAR) 126a hardware, etc., to generate different responding digital signals to activate and guide various actuators, for example, electric motors, to move wheels 111a and 111b of the vehicle 102 to run forward or backward with related angles, thereby allowing the mobile security robot 100 to travel in a predefined travel path to perform patrolling in a patrol area.

In an embodiment, the mobile security robot 100 comprises multiple sensors, devices, and a network located inside the human-sized mannequin 101, as an integral part of the mobile security robot 100. In an embodiment, cameras are operably coupled to the eye sockets of the human-sized mannequin 101. In an embodiment, the human-sized mannequin 101 is configured to detect humans in the patrol area through object recognition software. Image data together with other inputs from the other sensors, for example, light detection and ranging (LIDAR) 126a devices, ultrasound sensors, etc., capture environmental objects, for example, landmarks, waypoints, longitude, latitude, etc., of a patrol path of the mobile security robot 100. In another embodiment, a microphone is installed in the mouth of the human-sized mannequin 101 to allow communication with humans in the patrol area.

In an embodiment, the mobile security robot 100 further comprises a support frame 107 constituted by a main frame 107b and at least two triangle-poles 107c and 107d disposed behind the human-sized mannequin 101 on the vehicle 102 as illustrated in FIGS. 1C-1D. The two triangle-poles 107c and 107d are disposed on opposing sides of the main frame 107b as illustrated in FIGS. 1C-1D. In an embodiment, the main frame 107b is a generally U-shaped, main frame comprising tubular elements made, for example, of wood, steel, stainless steel, aluminum, etc. The two triangle-poles 107c and 107d support the main frame 107b on the vehicle 102. In an embodiment, the support frame 107 is fastened to the vehicle using fasteners, for example, screws, bolts, etc. The support frame 107 is configured to support the human-sized mannequin 101 and preclude the mobile security robot 100 from being overturned and damaged due to the low center of gravity design of the mobile security robot 100. The low center of gravity design and the two triangle-poles 107c and 107d reduce the chance of the mobile security robot 100 being overturned or damaged by perpetrators. In an embodiment, the mobile security robot 100 further comprises one or more loudspeakers 137 and/or flashing light devices 108 configured to convey alerts and warnings in the patrol area. In an embodiment, the loudspeakers 137 and the flashing light devices 108 are disposed on a top side 107a of the support frame 107 above the human-sized mannequin 101. In an embodiment, the flashing light devices 108 are bright three-color flashing lights, for example, red, blue, and white flashing lights, equipped with a siren. Equipped with the loudspeakers 137 and the flashing light devices 108, the mobile security robot 100 can zoom in on trouble-makers and other perpetrators and take aggressive action to chase them away. With the loudspeakers 137 and the flashing light devices 108 on the top side 107a of the support frame 107, the height of the mobile security robot 100 reaches, for example, from about 5.7 feet to about 6 feet.

The mobile security robot 100 further comprises a video recording system 103. In an embodiment, the video recording system 103 of the mobile security robot 100 is disposed in the human-sized mannequin 101, for example, on the neck of the human-sized mannequin 101 as illustrated in FIG. 1A. In an example, the video recording system 103 is a surveillance camera. In another embodiment (not shown), the video recording system 103 is disposed on the top side 107a of the support frame 107, proximal to the flashing lights 108, above the human-sized mannequin 101. The video recording system 103 is configured to continuously record images and video of the patrol area throughout the day and night. In an embodiment, three-dimensional (3D) cameras 113 with night vision are disposed on the top side 107a of the support frame 107 above the human-sized mannequin 101. The 3D cameras 113 are configured to capture images of surrounding activities in the patrol area at all times day and night.

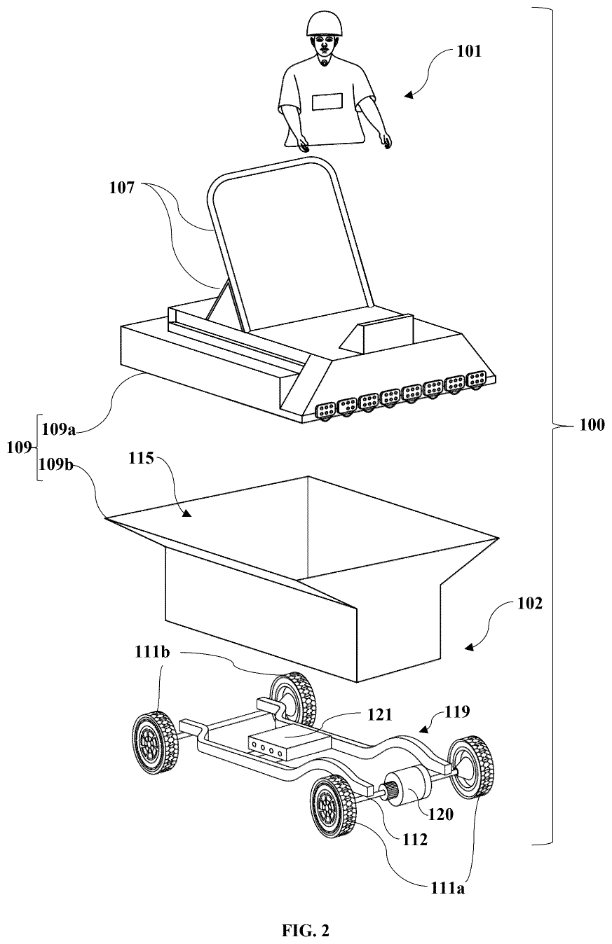

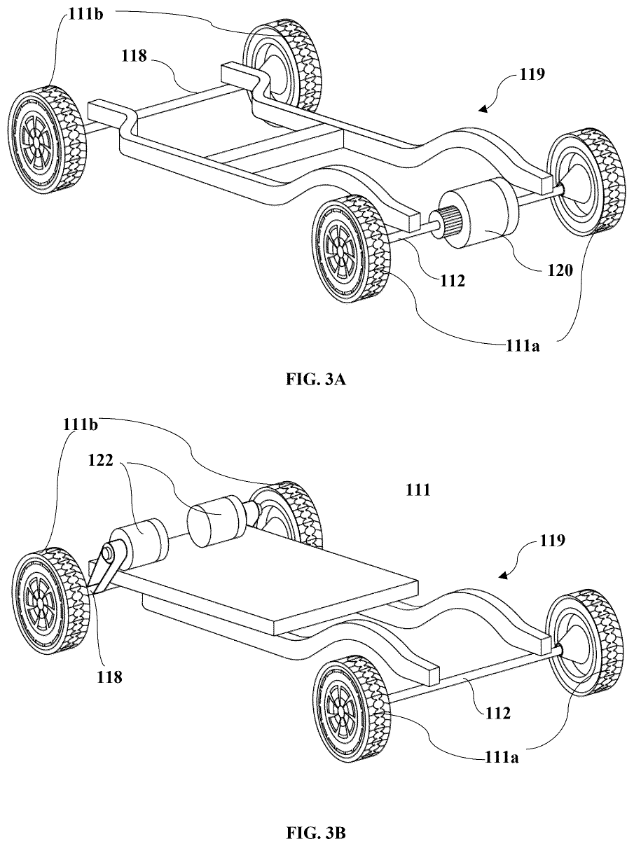

The vehicle 102 comprises a vehicle body 109, a chassis 119, and wheels 111a and 111b, as illustrated in FIG. 2. The chassis is further illustrated in FIGS. 3A-3B. In an embodiment, the vehicle body 109 comprises an upper section 109a and a lower section 109b. Multiple headlights 110 are operably coupled to a front end 109c of the upper section 109a of the vehicle body 109 as illustrated in FIG. 1A. The headlights 110 illuminate a patrol path in front of the mobile security robot 100. In an embodiment, each of the headlights comprise a predetermined number of light emitting diode (LED) lights, for example, about six (6) LED lights. In an embodiment, at least two red taillights 117 are operably coupled to a rear end 109d of the lower section 109b of the vehicle body 109 as illustrated in FIG. 1B. The taillights 117 provide illumination at the rear of the mobile security robot 100 to allow the mobile security robot 100 to be viewed in the patrol area. In another embodiment, a reverse warning light 116 is operably coupled to a rear end 109e of the upper section 109a of the vehicle body 109 as illustrated in FIG. 1B. The reverse warning light 116 is configured to provide illumination when a reverse gear of the vehicle 102 is engaged. The reverse warning light 116 is activated when the reverse gear of the vehicle 102 is engaged to signal vehicles coming from behind the mobile security robot 100 that the mobile security robot 100 is being reversed. In an embodiment, the vehicle 102 is painted with eye-catching or attention-grabbing colors, for example, distinguishing red and white colors, which along with the police-like or security guard-like, human-sized mannequin 101, demonstrates authority with flashing lights, to keep children and perpetrators away.

The mobile security robot 100 further comprises a storage unit 115 mounted on the chassis 119 of the vehicle 102 for storing additional equipment to expand the performance abilities of the mobile security robot 100. In an embodiment, the storage unit 115 forms part of the lower section 109b of the vehicle body 109 as illustrated in FIG. 1B and FIG. 1E. The storage unit 115 is a physical platform that provides a large, three-dimensional space for storing the additional equipment as modules with added functions. The human-sized mannequin 101 is mounted on the vehicle 102 in a seated position, proximal to the storage unit 115. In an embodiment, the human-sized mannequin 101 is mounted in front of the storage unit 115 on the vehicle 102 as illustrated in FIGS. 1C-1D. The storage unit 115 is disposed between the reverse warning light 116 and the taillights 117 behind the human-sized mannequin 101. The storage unit 115 provides a substantially large capacity and is configured to store multiple security devices and multiple high-powered energy storage devices, for example, as high as 100 kilowatt hour (kWh)/48-Volt batteries, for facilitating extended patrols without recharge. The high-powered energy storage devices constitute a power supply system of the mobile security robot 100 and power the mobile security robot 100. The high-powered energy storage devices are, for example, rechargeable lithium polymer (LiPo) batteries, configured to allow the mobile security robot 100 to perform strategic patrols for a long time, for example, about 40 hours to more than about 50 hours, before being recharged. The high-powered energy storage devices are configured with a substantially long working life, for example, about 5 years. The mobile security robot 100 utilizes a battery recharging system and electricity to recharge their high-powered energy storage devices in assigned charging areas. The storage unit 115 provides a substantially large, three-dimensional (3D) space with length, width, and height for storing enough batteries to conduct long, strategic patrols without a recharge, thereby significantly improving performance of the mobile security robot 100. The security devices stored in the storage unit 115 comprise, for example, a pair of robotic arms, sensors such as heat sensors and radioactive sensors for detecting fires, dangerous materials, etc., medical equipment, emergency devices, fire extinguishers, weapons such as rifles, wielding guns, water guns, etc., bullet-proof shields, protective covers, supply devices, repair devices, and supplementary robots. In an embodiment, the weapons are commandeered jointly with officers.

With the large 3D space provided by the storage unit 115, the mobile security robot 100 can quickly transform their original physical shape into another shape by adding supplementary attachment devices and other functional modules, for example, smaller-sized robots, to them, taking advantage of the large physical platform, for diverse purposes. Transforming the shape of the mobile security robot 100 by adding additional robot modules on them, not only has a surprise effect on perpetrators, but also adds utility to the mobile security robot 100 with less costs.

In an example, a robotic arm, that is, a separate, stationary robot with a water gun spreading capacity, is added to the mobile security robot 100 to allow the mobile security robot 100 to shoot red-ink or water to perpetrators to create evidence. In another example, a robotic arm, that is, a separate robot with a large sledge hammer, is added to the mobile security robot 100 to allow the mobile security robot to force-break doors for police. In another example, steel shields that are stored in the storage unit 115 are used by officers to protect themselves from bullets. In another example, the mobile security robot 100 is configured as a host robot to piggyback other smaller robots or a group of smaller robots. The mobile security robot 100 is configured to carry smaller robots by letting the smaller robots to ride thereon for faster driving speed, to transport the smaller robots to a targeted area and then to offload the smaller robots to perform other tasks.

The wheels of the vehicle 102 comprises front wheels 111a and rear wheels 111b as illustrated in FIGS. 1A-1F. The front wheels 111a are connected to each other by a front axle shaft 112 extending therebetween as illustrated in FIG. 1A and FIG. 1F. The rear wheels 111b are connected to each other by a rear axle shaft 118 extending therebetween as illustrated in FIG. 1B and FIG. 1F. In an example, the diameter of each of the wheels 111a and 111b is, for example, more than about 21 inches. The wheels 111a and 111b accommodate tires made, for example, of rubber. The rubber tires allows the mobile security robot 100 to move optimally on urban roads. In an embodiment, the vehicle 102 is an autonomous electric vehicle. In another embodiment, the vehicle 102 is a piston-operated vehicle. In an example, the vehicle 102 is about 5 feet in length and about 4 feet in width, equipped with 21-inch tires. In another example, the height of the vehicle 102 is more than about 5 feet. The large, multi-wheeled, mobile security robot is suitable to operate in urban and suburban paved roads, on its own on an autonomous basis for security patrols. The shape of the mobile security robot 100 is similar to a police officer driving a police patrol car. With its size, colors, and shape similar to a police officer driving a patrol car, the mobile security robot 100 scares off offenders.

The mobile security robot 100 disclosed herein is configured to observe, record, and intimidate perpetrators while interacting with people in need, to provide assistance. In an embodiment, with their self-driving ability and navigation system, the mobile security robot 100 is configured to select optimal patrol routes using internal navigation maps and engineering devices. With video recordings and image recognition capabilities, the mobile security robot 100 records environmental activities while on patrol. Using voice recognition systems, the mobile security robot 100 understands words in multiple natural languages, for example, English, French, German, Spanish, etc., and communicates with people in need using the built-in loudspeaker 137. Using wireless technology, for example, fifth generation (5G) wireless technology, human supervisors at control stations, in communication with the mobile security robot 100, can monitor patrol situations of the mobile security robot 100. The human supervisors at the control stations can talk directly to people in need to follow-up on suspicious activities at any time, even at night.

FIG. 2 illustrates an exploded, perspective view of the embodiment of the vehicle-mounted, human-like, mobile security robot 100 shown in FIG. 1A. The exploded view in FIG. 2 illustrates the human-sized mannequin 101, the upper section 109a and the lower section 109b of the vehicle body 109, and the chassis 119 for mounting the vehicle body 109. The upper section 109a of the vehicle body 109 houses the support frame 107. The lower section 109b of the vehicle body 109 houses the storage unit 115. The human-sized mannequin 101 is disposed on the upper section 109a of the vehicle body 109. In an example, the measurement of the vehicle body 109 is about 5.5 feet×3.5 feet×6 feet based on a 4 feet×3 feet chassis 119 of the vehicle 102. With the above-disclosed measurements and the large three-dimensional (3D) space provided by the storage unit 115, the mobile security robot 100 stores and carries large, heavy batteries, for example, lithium ion batteries, lithium iron phosphate (LiFePO4) batteries, etc., and use large electric motors 120 and 122 illustrated in FIGS. 3A-3B to power the wheels 111a and 111b with a wide range of speed, for example, about 3 mph to more than about 100 mph, thereby responding to different needs while on patrol. In an embodiment, the mobile security robot 100 is built with a low gravity design with heavy batteries of, for example, about 300 pounds (lbs), located in a lower bottom area of the storage unit 115. The low gravity design with the large weight of the batteries prevents the mobile security robot 100 from being damaged or overturned by perpetrators. The low gravity design helps the mobile security robot 100 to expand into larger dimensions, that is, from a small car size to a truck size so that additional functional modules, for example: (i) robotic arms to: (a) spread red-ink onto perpetrators, or (b) to spread water or a fire retardant from its reservoir to make the mobile security robot 100 function like a robotic firefighter working at a fire infernal to relieve human firefighters; or (ii) a bullet-proof shield as an armor can be added to the mobile security robot 100 to protect officers who command the mobile security robot 100 for a hostage situation; or (iii) to serve as a carrying platform to transport or carry other smaller robots, drones, and material for a joint-security operation. The large 3D space provided by the mobile security robot 100 further equips multiple electronic devices, for example, a television (TV) monitor panel, in front of the mobile security robot 100 to communicate with people face-to-face similar to a videotelephony conference setup, with audio devices that understand human talk in multiple natural languages using voice recognition, speech recognition, and natural language processing (NLP) technology, thereby allowing the mobile security robot 100 to respond to people's verbal requests.

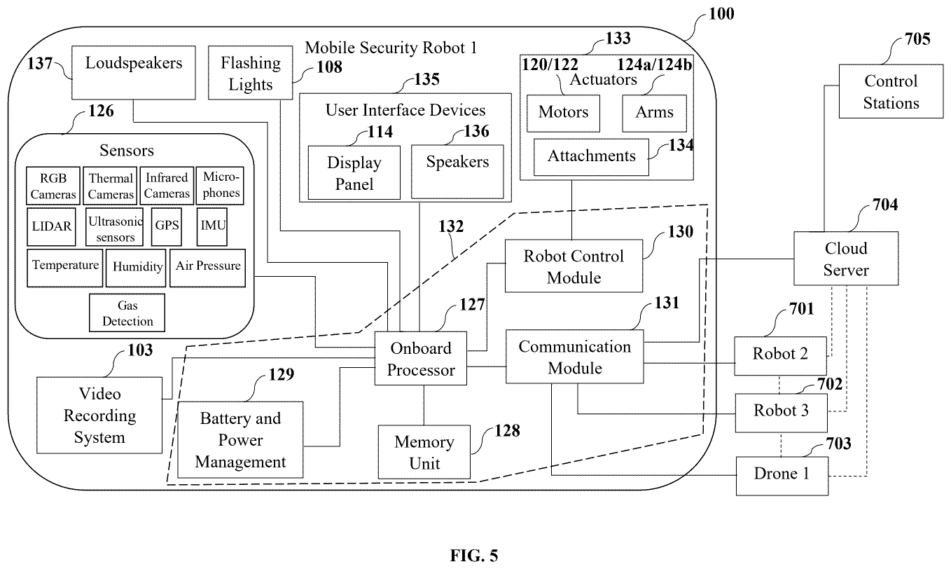

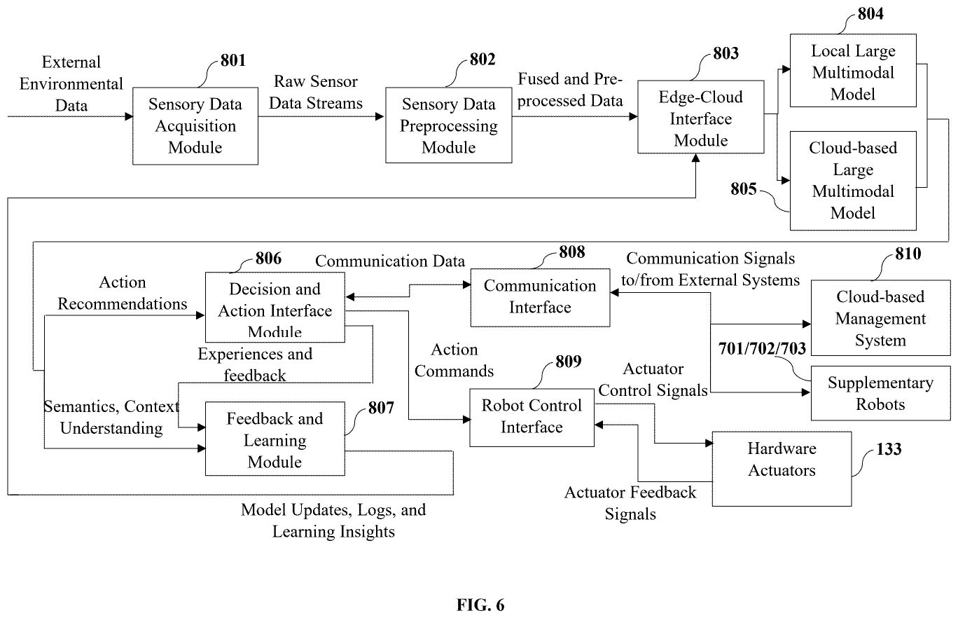

The exploded view in FIG. 2 also illustrates an electric motor 120 operably coupled to the front axle shaft 112 for operating the front wheels 111a of the vehicle 102. In an embodiment, a computer chassis 121 is disposed on the chassis 119 of the vehicle 102 as illustrated in FIG. 2. In an embodiment, the computer chassis 121 is configured to encase a computing system 126 of the mobile security robot 100 illustrated in FIG. 5.

FIGS. 3A-3B illustrate perspective views of embodiments of the chassis 119 of the vehicle 102 configured to mount a human-sized mannequin 101 shown in FIGS. 1A-1F, thereon. In an embodiment, the chassis 119 of the vehicle 102 is configured as an H-shaped metal frame as illustrated in FIGS. 3A-3B. In an embodiment, an electric motor 120, for example, a direct current (DC) motor, is operably coupled to the front axle shaft 112 of the vehicle 102 as illustrated in FIG. 3A to drive the front wheels 111a of the vehicle 102. Furthermore, in an embodiment, two electric motors 122, for example, DC motors, are operably coupled to the rear axle shaft 118 of the vehicle 102 as illustrated in FIG. 3B to drive the rear wheels 111b of the vehicle 102. The electric motors 120 and 122 run the vehicle 102 at different predetermined speeds with wheel speed feedback based on the environmental conditions and navigate the vehicle 102 along a predefined travel path with object avoidance using route maps and the robot operating system (ROS) navigation stack, during the patrols in the patrol area. The electric motors 120 and 122 move the mobile security robot 100 with various speeds based on environmental conditions. For example, the electric motors 120 and 122 move the mobile security robot 100 at a slow speed of about 3 mph in crowded areas, at a high speed of about 30 mph in open areas, and at about 100 mph in deserts for emergency missions and rescue missions. Using the H-shaped metal frame with two independent DC motors to accelerate the vehicle 102 and steer to make turns, the mobile security robot 100 improves its short turn radius and moves based on its internal path planning.

The PWM technology varies the duty cycle of a fixed frequency square wave, providing varying average power sent to the electric motors 120 and 122, resulting in different motor speed and thus speed of the mobile security robot 100.

The mobile security robot 100 illustrated in FIGS. 1A-1F implements autonomous drive technology with a build-in map, using the robot operating system (ROS) navigation stack with multiple electromechanical components, for example, batteries, motors 120 and 122 shown in FIGS. 3A-3B, wheels 111a and 111b, microcontrollers, etc., to move the mobile security robot 100 in a predetermined travel path with stationary and dynamic objects avoidance abilities without human intervention.

The mobile security robot 100 is configured to move at various predetermined speed limits using a preset path planning system using ROS navigation. The preset path planning system allows the user to set a starting point, a goal point, and various waypoints along the path and associated velocities. For example, when the coordinates of an internal map stored in the mobile security robot 100 match with coordinates of a private or exempted area, for example, the Mojave Desert, rendered by the global positioning system (GPS) receiver with real time kinematics (RTK) in the mobile security robot 100, a robot control module in the mobile security robot 100 sends a control signal to the electric motors 120 and/or 122 to increase the speed of the vehicle 102 to a preset speed limit, for example, about 100 miles per hour (mph). When the mobile security robot 100 leaves the Mojave Desert, the robot control module in the mobile security robot 100 sends a control signal to the electric motors 120 and/or 122 to decrease the speed of the vehicle 102 to a preset speed limit, for example, about 30 mph for a certain 10 miles distance and then to further decrease its speed to a preset speed limit, for example, about 3 mph, into a preset slow patrol mode, by reducing electrical voltage input to a motor controller, thereby reducing torque of the motors 120 and/or 122.

In an embodiment, the mobile security robot 100 comprises a 3-phase motor of, for example, 1.5 kWh, a motor controller, a potentiometer, and an actuator with a hardcoded software program, to manually control electrical voltage inputs, for example, from about 0 Volts (V) to about 5 V, to the motors 120 and/or 122, to generate different torques to drive the mobile security robot 100, for example, from about 0 mph up to about 50 mph with wheel speed feedback from Hall Effect sensors. Lubrication smoothens the speed changes in the mobile security robot 100.

Tabulated below are exemplary specifications for the mobile security robot 100:

| Parameter | | |
|---|---|---|
| Type | Parameter | Specification |
| Mechanical | Dimensions (mm) | 1550 × 980 × 710 |
| Parameters | Wheelbase (mm) | 845 |
| | Front/Rear Wheel Track (mm) | 860 |
| | Weight (kg) | 280 |
| | Battery Type | One Lithium Battery 48 |
| | | Volts (V) 24 Ampere- |
| | | hours (Ah) |
| | Power Drive Motor | Permanent Magnet |
| | | Synchronous DC Motor |
| | Steering Drive Motor | DC Servo Motor 2*400 |
| | | Watts (W) |
| | Drive Gearbox | 1:23 |
| | Steering Gearbox | 1:40 |
| | Parking Method | DC Electromagnetic |
| | | Brake |
| | Steering | Front/Rear Wheel |
| | | Ackermann |
| | Encoder | Incremental Magnetic |
| | | Encoder 102 |
| | Maximum Inner Wheel | 21° |
| | Steering Angle | |
| Performance | Maximum Speed (Empty) | 3 |
| Parameters | (m/s) | |
| | Minimum Turning Radius (m) | 1.9 |
| | Maximum Climbing Ability | 10°-20° |
| | Minimum Ground Clearance | 160 |
| | (mm) | |
| | Operating Temperature | −10° C.-45° C. |
| | Maximum Obstacle Clearance | 120 |
| | Height (mm) | |
| | Payload (kg) | 300 |
| Control | Control Mode | Remote Control |
| Parameters | Remote Control | 2.46/Max. Distance 100 m |
| | Communication Interface | Controller Area Network |
| | | (CAN) bus |

In an embodiment, the computing system 132 illustrated in FIG. 5, receives input data comprising analog information from the sensors 126 of the mobile security robot 100 illustrated in FIG. 5, and converts the input data into digital information, processes the digital information in nodes of a robotic operating system (ROS) to move the wheels 111a and 111b of the vehicle 102 and provide angular motion and action to steer the mobile security robot 100. In an embodiment, the mobile security robot 100 uses the ROS to provide two-way communication in a network among different nodes.

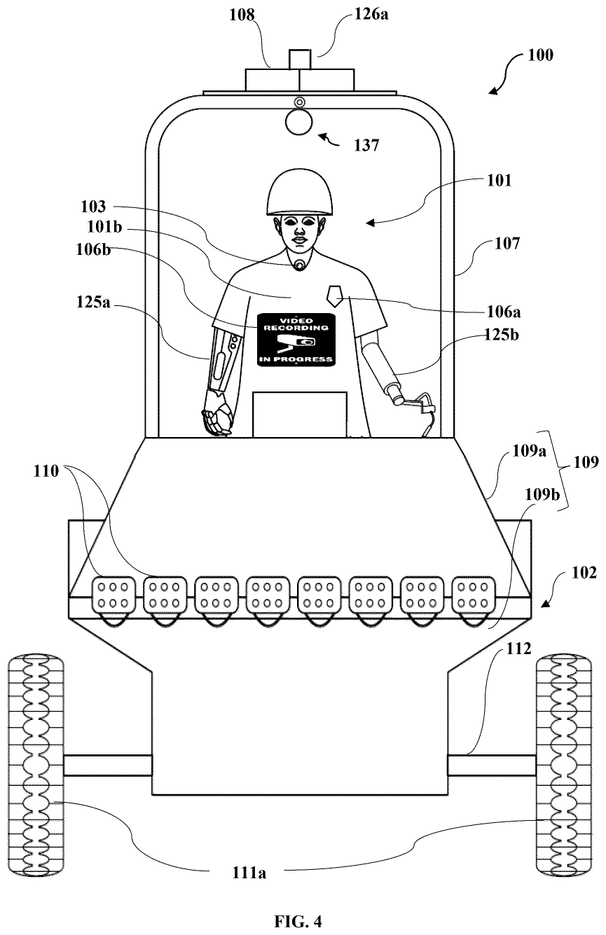

FIG. 4 illustrates a front elevation view of an embodiment of the vehicle-mounted, human-like, mobile security robot 100 comprising robotic arms 125a and 125b. In an embodiment, separate, functional units or modules are added to the mobile security robot 100 to modify the body of the human-sized mannequin 101 or the mobile security robot 100 as a whole. For example, the stationary arms of the human-sized mannequin 101 are replaced with separate robotic arms 125a and 125b to allow the mobile security robot 100 to conduct different tasks. The robotic arms 125a and 125b are operably coupled to the torso of the human-sized mannequin 101 of the mobile security robot 100 as illustrated in FIG. 4. The mobile security robot 100 is equipped with a torso of, for example, about 3 feet in height, that can add two robotic arms 125a and 125b to perform added functions. The robotic arms 125a and 125b are configured to carry out one or more of multiple tasks in the patrol area. The tasks comprise, for example: shooting a colored fluid, for example, red ink, towards unlawful elements; holding a striking tool such as a hammer, a baton, etc., to break barriers for inspection; providing shields for protection from bullets and shrapnel; offloading supplementary robots to a target patrol area to perform another one or more of the plurality of tasks; holding a water hose to one of extinguish a fire and solder metals in a shipyard; etc. In an example, the mobile security robot 100 is used as an early warning system for riot control by using the robotic arms 125a and 125b to perform one or more tasks, for example, spreading or shooting red ink towards targets. In an embodiment, the robotic arms 125a and 125b are configured to be moved in communication with the robot control module 130 of the mobile security robot 100 illustrated in FIG. 5, for directing traffic and a crowd in the patrol area.

In an embodiment, the mobile security robot 100 is configured to transform itself into another physical machine using one or more of the actuators to perform supplementary functions for protection, safety, and defence. For example, using the robotic arms 125a and 125b and the supplementary attachment devices such as bullet-proof steel shields, the mobile security robot 100 is converted into a self-driven, armored vehicle for other special operations and for providing protection and assistance to law enforcement officers. In an embodiment, the mobile security robot 100 is configured to be overtaken and/or commandeered by officers. For security and border patrol purposes, the mobile security robot 100 is configured to carry weapons, nuclear or biological bomb detectors, and emergency devices of the officers to help neutralize threats. With the combined abilities from both the officers and the mobile security robot 100, the mobile security robot 100 expands its performance quality with increasing marketability. In an embodiment, by using the robotic arms 125a and 125b, a human operator together with the mobile security robot 100 can perform bomb detection and anti-riot maneuvers.

In an embodiment, the mobile security robot 100 is configured to store supplementary attachment devices, for example, protective aegis or protective covers to provide a chemical, biological, radiological, and nuclear (CBRN) defense in situations where chemical, biological, radiological, and nuclear hazards are present to elevate capabilities of patrol performed by the mobile security robot 100, for revenue. In an example, a protective aegis or protective cover protects government agents from chemical, biological, radiological, and nuclear hazards. In another example, when a water hose is installed in one of the robotic arms 125a and 125b, the robot control module 130 generates action commands to instruct the robotic arm 125a or 125b to spread water or a fire retardant from its reservoir. The mobile security robot 100 is therefore transformed into a firefighting machine to work along with human firefighters, and take a leading role on dangerous fire infernal assignments. The added functions of the mobile security robot 100 are accomplished as the mobile security robot 100 is autonomous and moves swiftly with its large tires and electrical power. The autonomous mobile security robot 100 identifies fire conditions using its sensors, for example, cameras, heat sensors, etc., and responds to preprogramed firefighting commands to put out fires.

In another example, the stationary arms of the human-sized mannequin 101 are replaced with two welding robotic arms 125a and 125b to convert the mobile security robot 100 into a metal welding machine using multiple electric arc processes to bond metals together. The mobile security robot 100 supplies the battery power for the electrical welding to bind multiple pieces of metals together to help build ships in a shipyard. As disclosed in the above examples, adding functional modules to the mobile security robot 100 changes the physical shape of the mobile security robot 100 and expands the mobile security robot 100 to perform different roles.

FIG. 5 illustrates an architectural block diagram of an embodiment of a hardware implementation of the vehicle-mounted, human-like, mobile security robot 100. In addition to the human-sized mannequin 101 mounted on the vehicle 102, the storage unit 115, and the video recording system 103 illustrated in FIGS. 1A-1F, the mobile security robot 100 further comprises multiple sensors 126, the computing system 132, multiple actuators 133, multiple user interface devices 135, and multiple output devices, for example, 108 and 137. The sensors 126 are electronic, high technology (hi-tech) equipment configured to capture conditions and environment, for example, images, lights, sound, touches, etc., of the mobile security robot 100 and to provide the captured signals to one or more processors 127 or microcontrollers of the mobile security robot 100 for appropriate actions, thereby making the mobile security robot 100 to behave effectively for predetermined purposes. In an embodiment, the sensors 126 of the mobile security robot 100 are mounted on and/or proximal to the human-sized mannequin 101. In another embodiment, one or more of the sensors 126 are mounted on and proximal to the vehicle 102.

The sensors 126 are configured to detect and capture environmental conditions of the patrol area and generate sensor data comprising, for example, audio data, audiovisual data, light data, tactile data, image data, video data, and environmental data of the patrol area. The sensors 126 comprise visual sensors, auditory sensors, environmental sensors, ranging sensors, and localization sensors. The visual sensors comprise cameras for capturing red, green, and blue (RGB), thermal, and infrared images. The auditory sensors comprise microphones for capturing sound and speech in various frequencies. The environmental sensors are configured to detect environmental conditions, for example, temperature, humidity, gas, etc. The ranging sensors comprise, for example, light detection and ranging (LiDAR) sensors 126a and ultrasonic sensors for creating a full 360-degree, three-dimensional (3D) view of an environment of the mobile security robot 100 to generate real-time 3D data. An example of the LiDAR sensors 126a is the Velodyne LiDAR® sensors of Velodyne Lidar USA, Inc. The ranging sensors are used for navigation of the mobile security robot 100 in environments with varying terrains, obstructions, etc. The localization sensors comprise, for example, global positioning system (GPS) sensors, inertial measurement units (IMUs), etc., for determining the position of the mobile security robot 100. In an exemplarily implementation, the sensors 126 comprise one or more of RGB cameras, thermal cameras, infrared cameras, stereo depth cameras, microphone arrays, LIDAR devices 126a, ultrasonic sensors, GPS sensors, IMUs, temperature sensors, humidity sensors, air pressure sensors, gas detection devices, Hall effect sensors, etc.

The computing system 132 of the mobile security robot 100 is operably coupled to the sensors 126. The computing system 132 comprises at least one on-board processor 127, a non-transitory, computer-readable storage medium, for example, a memory unit 128 operably and communicatively coupled to the processor(s) 127, and a robot control module 130. The processor(s) 127 refers to one or more microprocessors, central processing unit (CPU) devices, finite state machines, computers, microcontrollers, digital signal processors, logic, logic devices, application-specific integrated circuits (ASICs), field-programmable gate arrays (FPGAs), chips, etc., or any combination thereof, capable of executing computer programs or a series of commands, instructions, or state transitions. In an embodiment, the processor(s) 127 is implemented as a processor set comprising, for example, a programmed microprocessor and a math or graphics co-processor. The computing system 132 is not limited to employing the processor(s) 127. In an embodiment, the computing system 132 employs a controller or a microcontroller. In another embodiment, the processor(s) 127 comprises a graphics processing unit (GPU) configured to perform on-board processing of multiple artificial intelligence (AI) models comprising, for example, large multimodal models (LMMs), and other computations. An example of the processor(s) 127 utilized in the mobile security robot 100 is an image processor(s) of NVIDIA Corporation. The processor(s) 127 is configured to perform real-time processing and execute computer program instructions defined by various modules of the computing system 132. The processor(s) 127 executes advanced image processing techniques to improve memory usage and power consumption. In an embodiment, the computing system 132 utilizes a complete operating system, for example, the Ubuntu® Linux-based operating system of Canonical Limited Company, for implementing the mobile security robot 100 in a cloud computing environment. As used herein, “cloud computing environment” refers to a processing environment comprising configurable, computing, physical, and logical resources, for example, networks, servers, storage media, virtual machines, applications, services, etc., and data distributed over a network, for example, the internet. The cloud computing environment provides an on-demand network access to a shared pool of the configurable, computing, physical, and logical resources.

Also, as used herein, “non-transitory, computer-readable storage medium” refers to all computer-readable media that contain and store computer programs and data. Examples of the computer-readable media comprise hard drives, solid state drives, optical discs or magnetic disks, memory chips, a read-only memory (ROM), a register memory, a processor cache, a random-access memory (RAM), etc. The memory unit 128 is a storage unit used for recording, storing, and reproducing data, program instructions, and applications. In an embodiment, the memory unit 128 comprises a RAM or another type of dynamic storage device that serves as a read and write internal memory and provides short-term or temporary storage for information and instructions executable by the processor(s) 127. The memory unit 128 also stores temporary variables and other intermediate information used during execution of the instructions by the processor(s) 127. In another embodiment, the memory unit 128 further comprises a ROM or another type of static storage device that stores firmware, static information, and instructions for execution by the processor(s) 127. The memory unit 128 is configured to store computer program instructions, which when executed by the processor(s) 127, cause the processor(s) 127 to: receive the sensor data from the sensors 126; process the received sensor data using multiple AI models, and based on the processing of the received sensor data, generate action commands for execution of multiple tasks by the actuators 133. In an embodiment, the processing of the received sensor data comprises processing audio data to interpret human speech and respond to verbal requests of the humans in the patrol area by executing voice recognition and natural language processing (NLP) algorithms. Using speech recognition, NLP technologies, and directional microphones, the mobile security robot 100 understands natural languages, for example, the English language, detects directions of audio messages, and can respond to people's needs. In an embodiment, the speech recognition process comprises speech enhancement, feature extraction, acoustic modeling, and phonetic unit recognition as known in the art. In another embodiment, the processing of the received sensor data comprises processing image data to detect and identify multiple environmental objects in the patrol area using positioning algorithms, point cloud libraries, and one or more of the sensors; facilitate navigation of the vehicle 102 away from or toward the detected environmental objects; detect a fire using the image data in combination with temperature data received from temperature sensors operating with cameras on the human-sized mannequin 101; detect and digitize human poses in the image data using pose AI analysis for identifying suspicious humans and irregular activities in the patrol area; and perform advanced object tracking using computer vision algorithms.

In an embodiment, by using image recognition technology, optic cameras, and a point cloud stack, the mobile security robot 100 identifies people's faces, records license plates of vehicles, etc., to help people locate their parked cars. In another embodiment, by utilizing pose AI analysis, the mobile security robot 100 identifies suspicious individuals and irregular activities to focus on the foes. In pose AI analysis, Deep Neural Network (DNN) is often used to conduct human pose estimation. The steps involved are, for example, detecting and isolating an individual in an image, estimating the location of body parts, and calculating a pose for each individual. Through the pose AI analysis, the mobile security robot 100 performs pose detection and pose tracking to understand human body language. In an embodiment, the mobile security robot 100 is configured to move toward suspicious persons to inquire why they are present on a private premise. If needed, the mobile security robot 100 asks the suspicious persons to leave or warns that police will be called. In extreme cases, the mobile security robot 100 sprays a red-ink liquid on the intruders to chase them away from the private premise. The mobile security robot 100 video-records the red ink on an intruder's body as evidence for legal action.

In another embodiment, the processing of the received sensor data comprises processing audio data to follow-up with the identified suspicious humans and the irregular activities in the patrol area using generative AI along with the audio data received from the microphone arrays mounted on the human-sized mannequin 101. In an example, the processor(s) 127 executes the You Only Look Once (YOLO) algorithm for image processing of images, videos, etc., and performing object detection.

The AI models executed for processing the received sensor data comprise, for example, a large language model (LLM), a local LMM, a cloud-based LMM, and a deep neural network (DNN) model. Incorporating additional modalities to LLMs creates LMMs. The LMM refers to a complex AI model configured to process and understand data from multiple sensory modalities, for example, vision, speech, and text. The LMMs are configured to allow the mobile security robot 100 to have a more comprehensive understanding of their environment, communicate with humans, and perform a wide range of tasks through the actuators. In an embodiment, the memory unit 128 is configured to store the AI models. In another embodiment, the AI models are stored in secondary storage devices, for example, solid-state drives (SSDs), hard disk drives (HDDs), etc. In this embodiment, the AI models are loaded into the memory unit 128 as needed during inference. In another embodiment, the AI models are stored in cloud-based or distributed computing environments across multiple storage devices and loaded into the memory unit 128 as needed. In another embodiment, GPUs and other specialized hardware accelerators comprise dedicated memories for storing the AI models to maximize performance. The memory unit 128 and/or the other storage devices used for storing the AI models also store intermediate data and logs. In an embodiment, the memory unit 128 is configured to store computer program instructions, which when executed by the processor(s) 127, cause the processor(s) 127 to generate feedback for adjusting the AI models for future processing. With multiple features comprising deep neural network (DNN) technology, powerful batteries with jet propulsion engines, and the AI models, the mobile security robot 100 is configured to further analyze images with different shapes to enhance its own data management and improve its movement and behavior.

The robot control module 130 is operably coupled to the processor(s) 127 and is configured to control the actuators 133 based on the generated action commands. In an embodiment, the computing system 132 further comprises a communication module 131 operably coupled to the processor(s) 127 and to multiple supplementary robots 701, 702, 703, etc., and control stations 705 via a cloud server 704 as illustrated in FIG. 5. The supplementary robots comprise, for example, small robots 701 and 702, drones 703, etc. The supplementary robots 701 and 702 illustrated in FIG. 5 represent a fleet of robots and drones. The supplementary robots 701 and 702 are carried within the storage unit 115 and transported to a target area by the vehicle 102. In an embodiment, the mobile security robot 100 is configured as a host for carrying and transporting the supplementary robots 701 and 702 from one location to another for complicated security assignments. In an embodiment, the size of the storage unit 115 is increased to load additional high-powered energy storage devices to increase its power capacity, for example, from about 1.5 kWh to about 100 kWh. With the increased space, the mobile security robot 100 provides a platform to carry a platoon of smaller robots 701 and 702 and/or drones 703 to conduct long range, complicated patrols and move at a wide range of speeds, for example, from about 1 mph to about 50 mph. When the mobile security robot 100 expands its dimensions from a car size to a truck size, the mobile security robot 100 is used as a transporting vehicle to carry a large quantity of slow-moving robots, for example, about fifty slow-moving robots, to a target area, and then unload them for independent action. Moreover, due to the large battery capacity of the mobile security robot 100, the mobile security robot 100 can supply electricity to recharge the smaller robots 701 and 702 and/or the drones 703 that may need frequent recharging. In an embodiment, the supplementary robots 701 and 702 are recharged using the high-powered energy storage devices in the storage unit 115 and diagnosed, debugged, repaired, and maintained using the computing system 132. The dimensions of the mobile security robot 100, for example, a height of about 6 feet, a length of about 5 feet, and a width of about 4 feet creates a large space, allows the mobile security robot 100 to store enough batteries to conduct long, strategic patrols, and provides a basis for charging other small robots 701 and 702 and/or drones 703.

The communication module 131 is configured to upload and download data streams for processing, storage, and communications. The communication module 131 allows the mobile security robot 100 to upload and download data streams to the control stations 705 using wireless technology, for example, fifth generation (5G) wireless technology, for further communications and storage. The communication module 131 allows the mobile security robot 100 to communicate with a centralized cloud server 704 and with the supplementary robots 701, 702, 703, etc., if needed, for swarm robotics, cloud-based learning, etc. The centralized cloud server 704 provides scalable computational resources, allowing the mobile security robot 100 to offload data and heavy processing tasks. In an embodiment, the centralized cloud server 704 is configured to operate as a data repository for long-term learning and analytics.

In an embodiment, the communication module 131 communicates with the centralized cloud server 704, and in turn, to the control stations 705 via a network. The network is, for example, one of the internet, satellite internet, an intranet, a wireless network, a communication network that implements Bluetooth® of Bluetooth Sig, Inc., a network that implements Wi-Fi® of Wi-Fi Alliance Corporation, an ultra-wideband (UWB) communication network, a wireless universal serial bus (USB) communication network, a communication network that implements ZigBee® of ZigBee Alliance Corporation, a general packet radio service (GPRS) network, a mobile telecommunication network such as a global system for mobile (GSM) communications network, a code division multiple access (CDMA) network, a third generation (3G) mobile communication network, a fourth generation (4G) mobile communication network, a fifth generation (5G) mobile communication network, a long-term evolution (LTE) mobile communication network, a public telephone network, etc., a local area network, a wide area network, an internet connection network, an infrared communication network, etc., or a network formed from any combination of these networks. In an embodiment, using wireless technology, for example, fifth generation (5G) wireless technology, human supervisors at the control stations 705 can monitor patrol situations of the mobile security robot 100. The human supervisors can talk directly to people in need to follow-up on suspicious activities at any time, even at night. In an embodiment, the computing system 132 further comprises a battery and power management module 129 operably coupled to the processor(s) 127 and configured to provide a sustained power source to the mobile security robot 100 and manage power consumption based on task priority. The computing system 100 further implements a robot operating system (ROS) which provides a flexible framework for communicating various environmental inputs captured by the sensors 126.

The actuators 133 of the mobile security robot 100 are operably coupled to the robot control module 130 of the computing system 132. The actuators 133 comprises electric motors 120/122, robotic arms 125a/125b, and multiple supplementary attachment devices 134. The electric motors 120 and 122 are configured to run the vehicle 102 at multiple predetermined speeds with wheel speed feedback. This feedback is used for closed loop speed control to constantly adjust the voltage applied to the motors 120 and 122 to correct motor speed variations. The predetermined speeds range, for example, from about 3 miles per hour (mph) to about 100 mph. The electric motors 120 and 122 are further configured to navigate the vehicle 102 along a predefined travel path with object avoidance using route maps and a robot operating system (ROS) navigation stack, during patrols in the patrol area. The ROS navigation stack consists of components like, for example, map server, path planning, localization, and obstacle avoidance.

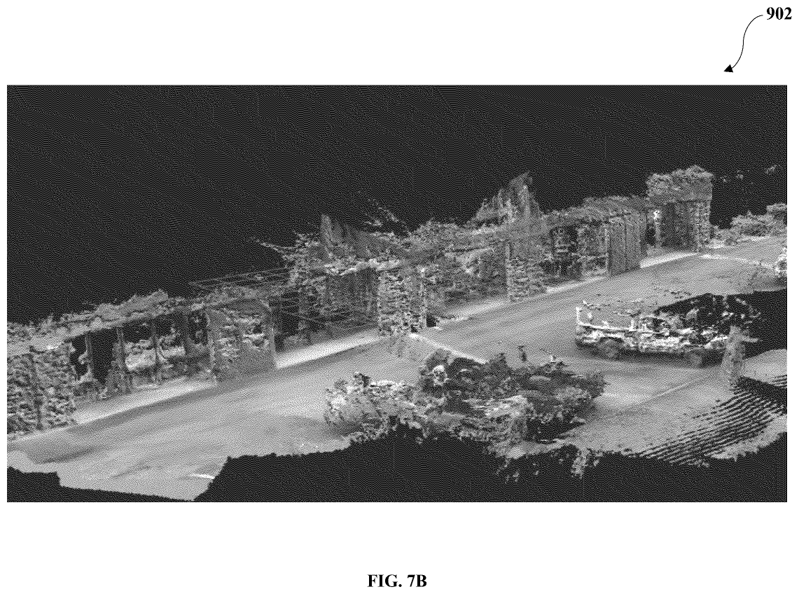

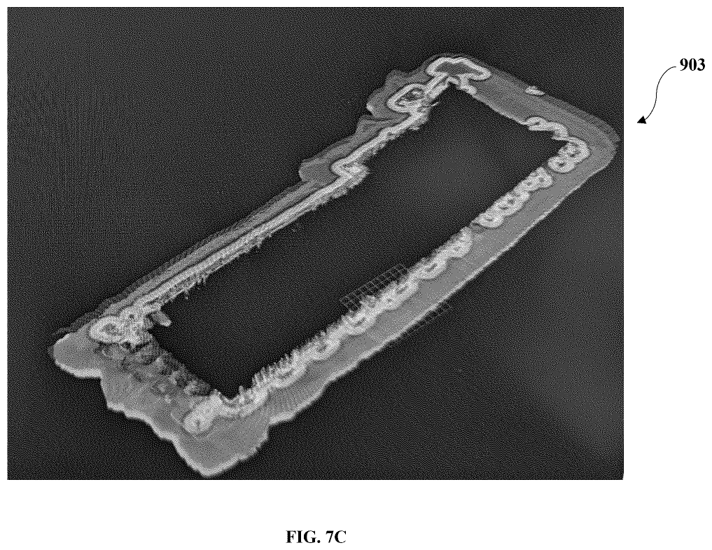

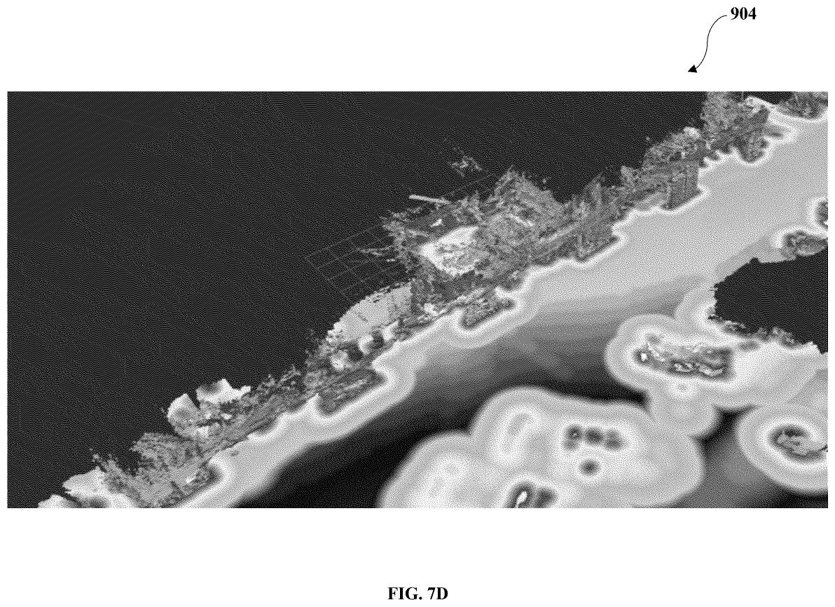

In an embodiment, the robot operating system (ROS) navigation stack comprises one or more grid ROS navigation maps 902 and 903 as illustrated in FIGS. 7B-7C, configured to allow the mobile security robot 100 to conduct outdoor patrols. In an embodiment, the grid ROS navigation maps 902 and 903 generated by the sensors 126 and the ROS navigation stack provide actual mappings of patrol areas, for example, a building. The mobile security robot 100 follows the grid ROS navigation maps 902 and 903 to monitor the patrol area. In an embodiment, the mobile security robot 100 utilizes a cost map 904 as illustrated in FIG. 7D, to avoid colliding with obstacles while on patrol as disclosed in the description of FIG. 7D. The cost map 904 receives the sensor data from the sensors 126 and generates a two-dimensional (2D) occupancy grid or a three-dimensional (3D) occupancy grid of the sensor data. In an embodiment, the mobile security robot 100 utilizes an object-avoidance map configured to guide the mobile security robot 100 to patrol in clear areas and avoid buildings and cars. In an embodiment, the object-avoidance map is equivalent to the cost map 904, which has high costs or high risk scores associated with the obstacles such as buildings and cars, and the navigation software will follow the preplanned patrol path if the cost along the route is low, and avoid the high-cost areas, which represent obstacles, either on-route or off-route.

In an embodiment, the Hall effect sensors are configured to provide the wheel speed feedback for adjusting the predetermined speeds to run the vehicle 102. In an embodiment, the robot control module 130 of the computing system 132, in communication with the electric motors 120 and 122 in the vehicle 102, is configured to control the speed of the vehicle 102 using pulse-width modulation technology with regenerative braking. The robot control module 130 and the actuators 133 allow the mobile security robot 100 to physically interact with its environment based on decisions and the action commands generated by the computing system 132. The robotic arms 125a and 125b are configured to carry out one or more of multiple tasks in the patrol area as disclosed in the description of FIG. 4. The supplementary attachment devices 134 comprise security devices, for example, wielding guns, water guns, etc., configured to carry out one or more of multiple tasks in the patrol area. The tasks comprise, for example, shooting a colored fluid towards unlawful elements, shooting water to extinguish a fire and/or solder metals in a shipyard; etc.

The user interface devices 135 of the mobile security robot 100 are operably coupled to the computing system 132. The user interface devices 135 are configured to facilitate auditory and visual communication with humans in the patrol area. In an embodiment, the user interface devices 135 comprise speakers 136 configured to communicate with humans in the patrol area. In another embodiment, the user interface devices 135 comprise one or more display panels 114 connected to a front side of the vehicle 102 for facilitating communication between the humans in the patrol area and the control stations 705. The user interface devices 135 provide human-robot interfaces with users via visual communication through the display panels 114 and via auditory communication through the speakers 136. The display panels 114 are, for example, touchscreen, light emitting diode (LED), display panels, accessible to people to allow the people to communicate with human supervisors at the control stations 705 to solve issues. The output devices of the mobile security robot 100 comprise loudspeakers 137 and/or flashing light devices 108 operably coupled to the computing system 132 for conveying alerts and warnings in the patrol area. With its network, the mobile security robot 100 knows when to activate the flashing light devices 108 and what information to announce through its loudspeakers 137 to scare off offenders.

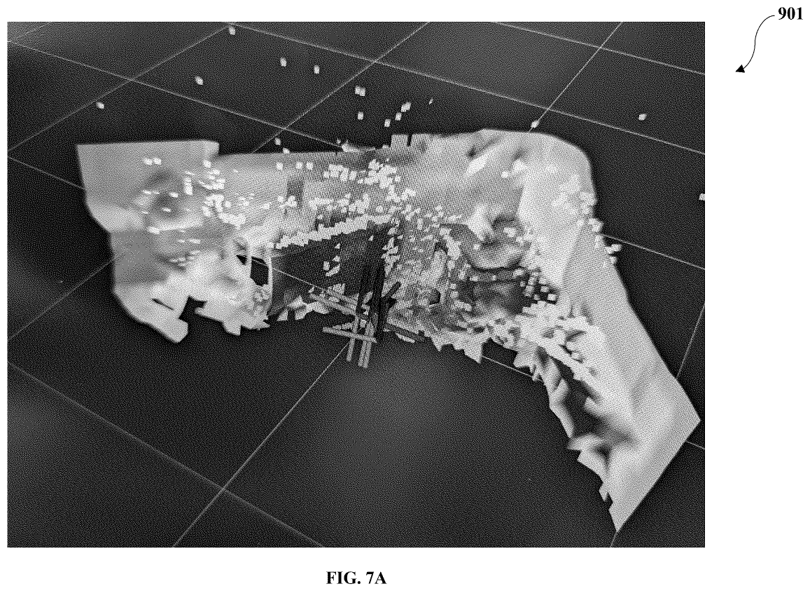

FIG. 6 illustrates a flowchart of an embodiment of a software implementation of the vehicle-mounted, human-like, mobile security robot 100 shown in FIGS. 1A-1F. In this embodiment, the software implementation of the vehicle-mounted, human-like, mobile security robot 100 comprises a sensory data acquisition module 801, a sensory data preprocessing module 802, an edge-cloud interface module 803, a decision and action interface module 806, a feedback and learning module 807, a communication interface 808, and a robot control interface 809. The sensory data acquisition module 801 gathers external environmental data, herein referred to as “sensor data”, from various sensors 126 illustrated in FIG. 5, and generates raw sensor data streams for preprocessing. The sensory data preprocessing module 802 performs cleaning and preprocessing of the raw sensor data streams. Cleaning and preprocessing of the raw sensor data streams comprises, for example, identifying and correcting errors in sensor datasets, filling in missing values, removing duplicates, handling outliers, noise reduction, data fusion, data transformation, data type conversion, data scaling, feature selection, feature extraction, normalization, etc. Preprocessing converts the raw sensor data streams into a format that machine learning algorithms can learn. The cleaned and preprocessed data ensures that the artificial intelligence (AI) models, for example, a local large multimodal model (LMM) 804 and a cloud-based LMM 805, receive high quality inputs for processing. The learning in the local LMM 804 and the cloud-based LMM 805 involves combining disjointed sensor data gathered from different sensors 126 and data inputs into a single model, resulting in more dynamic predictions than in unimodal systems, leading to generation of intelligent insights. The sensory data preprocessing module 802 combines sensor data received from multiple sensors to create a more robust and accurate representation of the environment. The sensory data preprocessing module 802 performs data fusion by executing sensor fusion algorithms comprising, for example, Kalman filters, particle filters, or other sensor-specific fusion techniques.

The edge-cloud interface module 803 receives the fused and preprocessed sensor data from the sensory data preprocessing module. The edge-cloud interface module 803 is a dedicated communication module that interfaces between the mobile security robot 100 and the cloud server 704 illustrated in FIG. 5. The edge-cloud interface module 803 determines whether processing should be performed on an edge device or be offloaded to the cloud server 704. If the edge-cloud interface module 803 determines that the processing should be performed on an edge device, the local LMM 804 processes the fused and preprocessed sensor data directly in the mobile security robot 100. If the edge-cloud interface module 803 determines that the processing should be performed on the cloud server, the edge-cloud interface module 803 sends the fused and preprocessed sensor data to the cloud server 704 for processing by the cloud-based LMM 805. The local LMM 804 and/or the cloud-based LMM 805 perform sensory fusion by integrating the sensor data from various sensors, for example, cameras, microphones, environmental sensors, etc., to create a unified and coherent representation of the environment surrounding the mobile security robot 100, thereby allowing the mobile security robot 100 to understand its surroundings.

The local LMM 804 and/or the cloud-based LMM 805 also analyze visual and auditory inputs to understand objects, people, and events in the environment of the mobile security robot 100 for allowing execution of tasks comprising, for example, navigation, object recognition, situational awareness, etc. The local LMM 804 and/or the cloud-based LMM 805 also process text and speech data to allow the mobile security robot 100 to understand and respond to human language for natural language interaction, voice commands, and communication with humans. The local LMM 804 and/or the cloud-based LMM 805 allow the mobile security robot 100 to understand and respond to spoken language or human inputs, interpret gestures and facial expressions, and provide responses in a multimodal manner. The local LMM 804 and/or the cloud-based LMM 805 exhibit advanced cognitive abilities comprising, for example, reasoning, problem-solving, and decision-making, by combining information from multiple sensors. The local LMM 804 and/or the cloud-based LMM 805 allow the mobile security robot 100 to navigate autonomously, taking into account visual information from cameras, spatial data from LIDAR 126a or other sensors, etc.

The local LMM 804 and/or the cloud-based LMM 805 output semantics, context understanding, and action recommendations. The feedback and learning module 807 receives the semantics and the context understanding from the local LMM 804 and/or the cloud-based LMM 805. The decision and action interface module 806 receives the action recommendations from the local LMM 804 and/or the cloud-based LMM 805. The decision and action interface module 806 operates based on insights generated by the local LMM 804 and/or the cloud-based LMM 805. The decision and action interface module 806 makes decisions based on the action recommendations from the local LMM 804 and/or the cloud-based LMM 805 and predefined or learned criteria. The decision and action interface module 806 also outputs experiences and feedback to the feedback and learning module 807. The feedback and learning module 807 adjusts the local LMM 804 and/or the cloud-based LMM 805 based on outcomes of the decisions, ensuring continuous learning and adaptation. The feedback and learning module 807 integrates real world outcomes back into the computing system 132 to improve future decision making. The feedback and learning module 807 sends model updates, logs, and learning insights to the edge-cloud interface module 803. The local LMM 804 and/or the cloud-based LMM 805 together with the decision and action interface module 806 and the feedback and learning module 807 constitute an AI engine of the computing system 132.

The decision and action interface module 806 generates and sends action commands to the robot control interface 809 hosted by the robot control module 130 of the computing system 132 illustrated in FIG. 5. The robot control module 130, via the robot control interface 809, generates and sends control signals to the actuators of the mobile security robot 100. The robot control module 130, via the robot control interface 809, receives feedback signals from the actuators. The decision and action interface module 806 also sends communication data to the communication interface 808 hosted by the communication module 131 of the computing system 132 illustrated in FIG. 4. The communication module 131, via the communication interface 808, sends and receives communication signals to and from external systems, for example, a cloud-based management system 810 of the cloud server 704, the supplementary robots 701, 702, 703, etc.

The sensory data acquisition module 801, the sensory data preprocessing module 802, the edge-cloud interface module 803, the decision and action interface module 806, the feedback and learning module 807, the communication interface 808, and the robot control interface 809 define computer program instructions executable by the processor(s) 127 of the computing system 132 illustrated in FIG. 5. In an embodiment, the modules 801, 802, 803, 806, 807, 808, and 809 are stored in the memory unit 128 of the computing system 132 illustrated in FIG. 5. The processor(s) 127 of the computing system 132 is configured to execute the modules 801, 802, 803, 806, 807, 808, and 809 for performing their respective functions disclosed above. The processor(s) 127 retrieves instructions defined by the 801, 802, 803, 806, 807, 808, and 809 from the memory unit 128 for executing their respective functions disclosed above.

In an example, the mobile security robot 100 is configured to: (a) assist the needy by providing immediate care or calling for help during a patrol; and (b) chase perpetrators away from the patrol areas using its police-like, large mobile presence, the 3-color, flashing lights 108, and the loudspeaker 137 to command people to leave. In another example, if needed, the mobile security robot 100 utilizes a water gun filled with red ink to spread red ink on an intruder to further intimidate the intruder, to deter or stop crime, and to enforce law and order. The mobile security robot 100 further utilizes its mobility and precision arm movements to execute specific functions, for example, holding a water hose to extinguish a fire or to solder metals in a shipyard. The mobile security robot 100 uses the large 3D space of the storage unit 115 to carry battery power and equipment to help supply or repair other devices such as drones.

The mobile security robot 100 is trained using AI technology comprising the LLM as disclosed above to recognize and comprehend the environmental stimuli, for example, images, sound, etc., in the patrol path, to know when and how to react to the environmental stimuli. In an embodiment, the mobile security robot 100 is configured to talk to suspicious people using generative AI, for example, using a large language model (LLM)-based chatbot such as ChatGPT™ of OpenAI OpCo, LLC, with microphone arrays to follow-up with suspicious people or on suspicious activities. Through the dialogue, the mobile security robot 100 receives more information and understands the intent of the suspicious people in the patrol area to allow proper action to be taken to deter a crime or to provide assistance to the needy.

An example of the functionality of the mobile security robot 100 is disclosed as follows. The sensors 126 of the mobile security robot 100 collect various physical signals of environmental conditions of a patrol area, for example, images of a building, people's speech, etc. The physical signals of environmental conditions are herein referred to as “environmental signals”. The computing system 132 of the mobile security robot 100 processes these environmental signals by executing AI algorithms tailored either for images, for example, face recognition algorithms, or tailored for audio sound such as a siren. The computing system 132 organizes the processed environmental signals into structured datasets, without infringing privacy laws. The computing system 132 utilizes the structured datasets as inputs for evaluation. During the evaluation, the computing system 132 assigns different weighted scores to different types of environmental signals. The computing system 132 comprises evaluators for aggregating and analyzing the weighted scores using the LLM. The evaluators with training are configured to interpret and predict the environmental signals into human-readable profiles. These human-readable profiles allow the mobile security robot 100 to recognize surrounding objects and understand spatial relationships between the surrounding objects, thereby allowing the mobile security robot 100 to predict and determine whether an object or an event is not normal in the environment, whether the mobile security robot 100 needs to follow up and act upon an object or an event, etc. Consequently, the mobile security robot 100 can assist people in need of help or stop perpetrators with malicious intent to commit a crime. When an abnormal flagging signal is activated, the mobile security robot 100 is configured to move toward the source of the abnormality for further investigation. The mobile security robot 100 may initiate a chat conversation, for example, using the ChatGPT chatbot, to gather further information and to confirm whether the observed behavior deviates significantly from baseline expectations. With its large, police-like, physical shape, the 3-color flashing lights 108 that flash on and off, and the loudspeaker 137, the mobile security robot 100 intimidates perpetrators and commands them to leave the area using the loudspeaker 137. If the command is not obeyed, in an example, the mobile security robot 100 shoots red ink on the perpetrators to further intimidate them, if needed, to chase them away, while recording all conversations and encounter images, to stop a crime. Relevant data captured during an encounter automatically generates new input for storage in a database of the mobile security robot 100, thereby expanding and improving the quality of the database. In an embodiment, the communication module 131 of the mobile security robot 100 wirelessly transmits the new input data to a human supervisor located in a remote control center at one or more of the control stations 705 for follow up.

Disclosed below are exemplary sequential steps performed by the mobile security robot 100 to analyze and understand environmental data. In this example, only two environmental sensory inputs, that is, image and audio, are used from the environment surrounding the mobile security robot 100.
Source 1 (from images): Cameras capture images—Object Recognition—(individual traits, age, sex, clothing, vehicle, etc.)—Tokenizer—Grader (LLM 1)—Flagger (LLM 2)—[pass onto other subsystems responsible for actions of the mobile security robot 100]
Source 2 (from sound): Microphones capture audio and speech—Audio Transcription—(speech, noises, sound of interests such as gun shots, siren, etc.,)—Tokenizer—Grader (LLM1)—Flagger (LLM 2)—[pass onto other subsystems responsible for actions of the mobile security robot 100], (to compare to the statistical norm/model.)

FIG. 7A illustrates a three-dimensional navigation cloud map 901 utilized by the vehicle-mounted, human-like, mobile security robot 100 shown in FIGS. 1A-1F, for navigating a patrol area.

FIGS. 7B-7C illustrate grid robot operating system (ROS) navigation maps 902 and 903 utilized by the vehicle-mounted, human-like, mobile security robot 100 shown in FIGS. 1A-1F, for navigating a patrol area. In an example, the navigation maps 902 and 903 illustrated in FIGS. 7B-7C map out a patrol path of an office building for the mobile security robot 100 to navigate. The navigation map 902 illustrated in FIG. 7B maps out a patrol path outside the office building, while the navigation map 903 illustrated in FIG. 7C maps out a patrol path inside the office building.

FIG. 7D illustrates a cost map 904 utilized by the vehicle-mounted, human-like, mobile security robot shown in FIGS. 1A-1F, for object avoidance during a patrol. The cost map 904 provides a configurable structure that maintains information about where the mobile security robot 100 should navigate in the form of an occupancy grid. The cost map 904 uses sensor data and information from a static map to store and update information about obstacles in the patrol area, for example, through a costmap_2d::Costmap2DROS object. The costmap_2d::Costmap2DROS object provides a two-dimensional interface where queries about obstacles are made in columns.

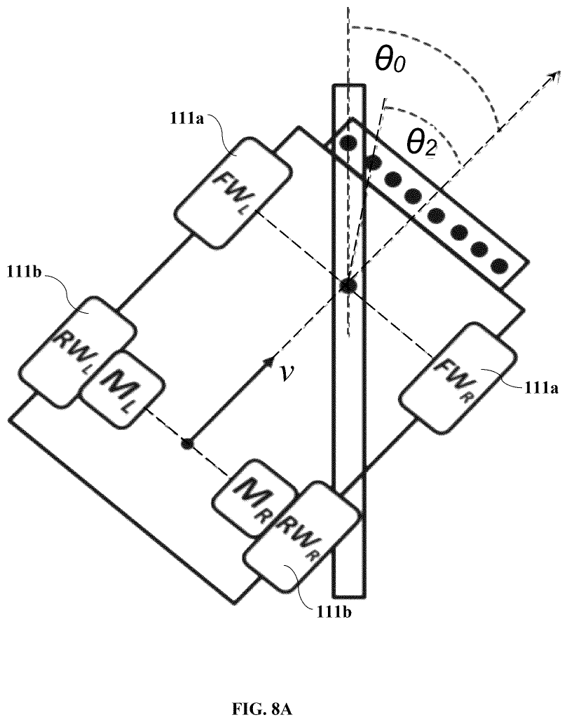

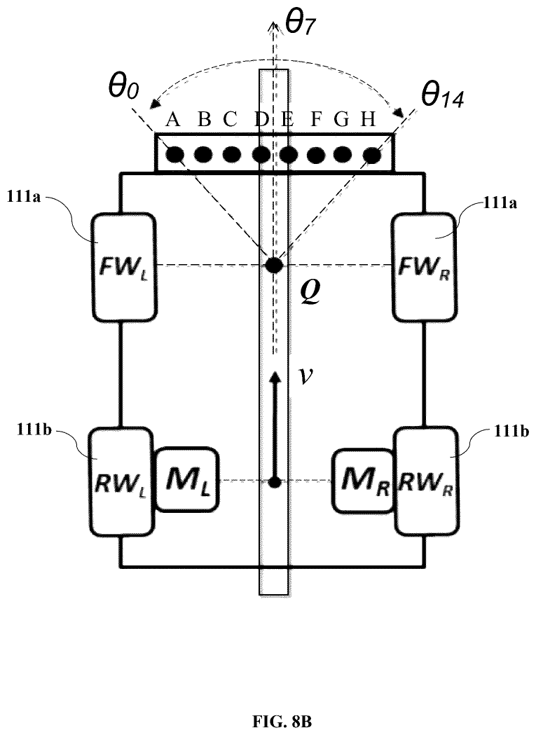

FIGS. 8A-8B illustrate bottom elevation views showing movement and object avoidance of an embodiment of the vehicle-mounted, human-like, mobile security robot 100 shown in FIGS. 1A-1F. Using positioning software, Point Cloud Libraries (PCLs) and hardware comprising a global positioning system (GPS) receiver with real time kinematics (RTK), depth cameras with inertial measurement units (IMUs) such as the Intel® RealSense® depth cameras of Intel Corporation, the mobile security robot 100 dodges objects swiftly, during patrol. Using AI software and hi-tech hardware, the mobile security robot 100 patrols on its own route maps, knows its positions and travelling directions, and completes its patrol objectives. In an embodiment, the mobile security robot 100 executes the Monte Carlo Localization (MCL) algorithm to estimate its position and orientation. The MCL algorithm uses a known map of the environment, range sensor data, and odometry sensor data. Using AI software and other hi-tech hardware, the mobile security robot 100 plans its travel path using built-in maps and grid-mapping. The mobile security robot 100 knows its own position by localization and an optimal travel direction, avoiding obstacles, and completes its patrol objectives. In an embodiment, the mobile security robot 100 using autonomous driving simulators, for example, the Gazebo simulator and the Carla simulator to recalibrate its system, thereby improving quality of security patrols. The security patrols performed by the mobile security robot 100 are to: (a) show the presence of the mobile security robot 100 in a patrol area; (b) observe activities; (c) record unusual events; and (d) report events and alert a human superior for follow-up action including contacting police.

To make a security patrol effective, the mobile security robot 100 shows its human-size mannequin 101, dressed in uniform with bright security wording and the signage of video-recording-in-process, with a flashing light and a loudspeaker, to intimidate an offender by bringing the offender to public attention. The human-sized mannequin 101 of the mobile security robot 100 demonstrates authority to an offender. With extra-large black rubber tires, a flashing light, and the sound of the loudspeaker, the mobile security robot 100 causes discomfort and becomes a threat to the offender. As a result, the offender walks away from the patrolling mobile security robot 100.

The mobile security robot 100 with the human-sized mannequin 101 wearing a bright uniform, for example, a bright yellow-colored uniform, and having an intimidating appearance, is programmed to patrol in and/or around a patrol area with a patrol plan for observing environmental conditions using the sensors 126 such as cameras, sound and other sensory devices; recording the environmental conditions using the built-in computing system 132; and detecting environmental objects using AI technology, thereby preventing crimes from occurring in the patrol path. The mobile security robot 100 overcomes the limitations of human patrols that are subject to fatigue, boredom, and weather conditions. Superior to a human guard, the mobile security robot 100 carries out its assignments without fatigue or boredom. The mobile security robot 100 is also not affected by hot weather temperature concerns. The infrared cameras allow the mobile security robot 100 to have improved visibility at night than human eyes. Using one or more supplementary attachment devices 134 illustrated in FIG. 5, the mobile security robot 100 can be converted into different physical machines for multiple different and complex assignments that would be challenging to humans. The mobile security robot 100 overcomes the limitations associated with human fatigue and continuously patrols a patrol area without interruption.

The mobile security robot 100 is large in size and human-shaped, thereby providing the same level of deterrence as human security personnel. Due to the large size and weight of the mobile security robot 100, similar to the size and weight of a passenger car, the mobile security robot 100 can carry powerful batteries, for example, 100 kWh batteries, to conduct long range patrols without re-charging, move or navigate at a wide range of speeds, for example, about 1 mile per hour (mph) to about 100 mph similar to a car, transform itself into another physical machine, for example, an armored vehicle for law enforcement agents, with low operating cost. The mobile security robot 100 travels at variable speeds with multiple motors and high battery capacity for facilitating extended patrols in challenging conditions continuously without recharge and interruption in urban and other environments. The human-sized mannequin 101 in the mobile security robot 100 dressed in a security uniform of attention-grabbing colors represents authority to the humans in the patrol area, thereby psychologically intimidating offenders. Moreover, the mobile security robot can carry a substantial amount of payload and patrol an urban area with variable speeds on urban roads. Furthermore, the mobile security robot 100 identifies suspicious humans and irregular activities in the patrol area, thereby protecting the patrol area from potential security and safety threats. The mobile security robot 100 being configured to operate on private roads is exempted from stringent safety requirements, thereby increasing marketability of the mobile security robot 100 in affluent communities. The mobile security robot 100 is powered by electricity, is environment-friendly, does not emit carbon dioxide, and executes quiet operations. The mobile security robot 100, when operated on a private road or on government-exempted premises, does not require governmental permits, thereby reducing operating costs of the mobile security robot 100.

The mobile security robot 100 is built using sturdy metal and alloys with integrated autonomous driving, path planning, and processing abilities. With a car inventory model, the mobile security robot 100 assists people in locating their vehicle 102 and accept parking payment for customers in the parking lot, making car parking a more comfortable experience. Using 5G wireless technology, the mobile security robot 100 relays images and spoken data to its human monitoring control stations for added verification, which improves quality of the security patrols. Moreover, the mobile security robot 100 protects cars, so that shoppers can stay longer shopping, thereby increasing revenue of shopping malls. The mobile security robot 100 patrols residential communities, so that residents can sleep better knowing the street is monitored day and night. The mobile security robot 100 provides a large, 3D space to carry other elements, for example, robotic arms, police officers, weapons, fire-extinguishers, bullet-proof shields, emergency medical equipment, radioactive and heat sensors, etc., to expand the operation of the mobile security robot 100, to fully utilize its computing and motoring capacities, and to reduce its operating costs.

It is apparent in different embodiments that the various methods, algorithms, and computer-readable programs disclosed herein are implemented on non-transitory, computer-readable storage media appropriately programmed for computing devices. The non-transitory, computer-readable storage media participate in providing data, for example, instructions that are read by a computer, a processor, or a similar device. In different embodiments, the “non-transitory, computer-readable storage media” also refer to a single medium or multiple media, for example, a centralized database, a distributed database, and/or associated caches and servers that store one or more sets of instructions that are read by a computer, a processor, or a similar device. The “non-transitory, computer-readable storage media” also refer to any medium capable of storing or encoding a set of instructions for execution by a computer, a processor, or a similar device and that causes a computer, a processor, or a similar device to perform any one or more of the steps of the method disclosed herein. In an embodiment, the computer programs that implement the methods and algorithms disclosed herein are stored and transmitted using a variety of media, for example, the computer-readable media in various manners. In an embodiment, hard-wired circuitry or custom hardware is used in place of, or in combination with, software instructions for implementing the processes of various embodiments. Therefore, the embodiments are not limited to any specific combination of hardware and software. Various aspects of the embodiments disclosed herein are implemented in a non-programmed environment comprising documents created, for example, in a hypertext markup language (HTML), an extensible markup language (XML), or other format that render aspects of a graphical user interface (GUI) or perform other functions, when viewed in a visual area or a window of a browser program. Various aspects of the embodiments disclosed herein are implemented as programmed elements, or non-programmed elements, or any suitable combination thereof.

Where databases are described, it will be understood by one of ordinary skill in the art that (i) alternative database structures to those described may be employed, and (ii) other memory structures besides databases may be employed. Any illustrations or descriptions of any sample databases disclosed herein are illustrative arrangements for stored representations of information. In an embodiment, any number of other arrangements are employed besides those suggested by tables illustrated in the drawings or elsewhere. In another embodiment, despite any depiction of the databases as tables, other formats including relational databases, object-based models, and/or distributed databases are used to store and manipulate the data types disclosed herein. In an embodiment, object methods or behaviors of a database are used to implement various processes such as those disclosed herein. In another embodiment, the databases are, in a known manner, stored locally or remotely from a device that accesses data in such a database. In embodiments where there are multiple databases, the databases are integrated to communicate with each other for enabling simultaneous updates of data linked across the databases, when there are any updates to the data in one of the databases.

The embodiments disclosed herein are configured to operate in a network environment comprising one or more computers that are in communication with one or more devices via a network. In an embodiment, the computers communicate with the devices directly or indirectly, via a wired medium or a wireless medium such as the Internet, satellite internet, a local area network (LAN), a wide area network (WAN) or the Ethernet, or via any appropriate communications mediums or combination of communications mediums. Each of the devices comprises processors that are adapted to communicate with the computers. In an embodiment, each of the computers is equipped with a network communication device, for example, a network interface card, a modem, or other network connection device suitable for connecting to a network. Each of the computers and the devices executes an operating system. While the operating system may differ depending on the type of computer, the operating system provides the appropriate communications protocols to establish communication links with the network. Any number and type of machines may be in communication with the computers.

The embodiments disclosed herein are not limited to a particular computer system platform, processor, operating system, or network. One or more of the embodiments disclosed herein are distributed among one or more computer systems, for example, servers configured to provide one or more services to one or more client computers, or to perform a complete task in a distributed system. For example, one or more of embodiments disclosed herein are performed on a client-server system that comprises components distributed among one or more server systems that perform multiple functions according to various embodiments. These components comprise, for example, executable, intermediate, or interpreted code, which communicate over a network using a communication protocol. The embodiments disclosed herein are not limited to be executable on any particular system or group of systems, and are not limited to any particular distributed architecture, network, or communication protocol.

The foregoing examples and illustrative implementations of various embodiments have been provided merely for explanation and are in no way to be construed as limiting the embodiments disclosed herein. Dimensions of various parts of the mobile security robot disclosed above are exemplary, and are not limiting of the scope of the embodiments herein. While the embodiments have been described with reference to various illustrative implementations, drawings, and techniques, it is understood that the words, which have been used herein, are words of description and illustration, rather than words of limitation. Furthermore, although the embodiments have been described herein with reference to particular means, materials, techniques, and implementations, the embodiments herein are not intended to be limited to the particulars disclosed herein; rather, the embodiments extend to all functionally equivalent structures, methods and uses, such as are within the scope of the appended claims. It will be understood by those skilled in the art, having the benefit of the teachings of this specification, that the embodiments disclosed herein are capable of modifications and other embodiments may be effected and changes may be made thereto, without departing from the scope and spirit of the embodiments disclosed herein.

We claim:

1. A mobile security robot comprising:
a vehicle;
a storage unit mounted on a chassis of the vehicle and configured to store a plurality of security devices and a plurality of high-powered energy storage devices for facilitating extended patrols without recharge;
a human-sized mannequin mounted on the vehicle, proximal to the storage unit;
a video recording system disposed in the human-sized mannequin and configured to continuously record images of a patrol area;
a plurality of sensors mounted on and proximal to the human-sized mannequin, wherein the sensors are configured to detect and capture environmental conditions of the patrol area and generate sensor data comprising audio data, audiovisual data, light data, tactile data, image data, video data, and environmental data of the patrol area;
a computing system operably coupled to the plurality of sensors, wherein the computing system comprises:
at least one processor;
a memory unit operably and communicatively coupled to the at least one processor and configured to store computer program instructions, which when executed by the at least one processor, cause the at least one processor to:
receive the sensor data from the plurality of sensors;
process the received sensor data using a plurality of artificial intelligence models; and
based on the processing of the received sensor data, generate action commands for execution of a plurality of tasks by a plurality of actuators; and
a robot control module operably coupled to the at least one processor and configured to control the plurality of actuators based on the generated action commands;
the plurality of actuators operably coupled to the robot control module of the computing system, wherein the plurality of actuators comprise:
electric motors configured to run the vehicle at a plurality of predetermined speeds with wheel speed feedback based on the environmental conditions and to navigate the vehicle along a predefined travel path with object avoidance using route maps and a robot operating system (ROS) navigation stack, during the patrols in the patrol area; and
robotic arms configured to carry out one or more of the plurality of tasks in the patrol area; and
a plurality of output devices comprising one or more of loudspeakers and flashing light devices operably coupled to the computing system and configured to convey alerts and warnings in the patrol area.

2. The mobile security robot of claim 1, wherein the human-sized mannequin is configured to resemble a human being comprising a movable head with a face, nose, eyes, and a mouth, and a torso, wherein the torso is about 3 feet high to about 4 feet high, and wherein the torso is rotatable from about 45 degrees to about 90 degrees.

3. The mobile security robot of claim 1, wherein the human-sized mannequin is dressed in a security uniform comprising a shirt, a security badge, and headgear in attention-grabbing colors representing authority to the humans in the patrol area.

4. The mobile security robot of claim 1, wherein the plurality of sensors comprises red, green, and blue (RGB) cameras, thermal cameras, infrared cameras, stereo depth cameras, microphone arrays, light detection and ranging (LIDAR) 126a devices, ultrasonic sensors, a global positioning system, inertial measurement units, temperature sensors, humidity sensors, air pressure sensors, gas detection devices, and a plurality of Hall effect sensors.

5. The mobile security robot of claim 4, wherein the Hall effect sensors are configured to provide the wheel speed feedback for adjusting the predetermined speeds to run the vehicle, wherein the predetermined speeds range from about 3 miles per hour to about 100 miles per hour.

6. The mobile security robot of claim 1, wherein the plurality of actuators further comprises a plurality of supplementary attachment devices comprising security devices configured to carry out another one or more of the plurality of tasks in the patrol area, wherein the plurality of security devices stored in the storage unit comprises robotic arms, heat sensors, radioactive sensors, medical equipment, emergency devices, fire extinguishers, weapons, bullet-proof shields, protective covers, supply devices, repair devices, and supplementary robots.

7. The mobile security robot of claim 6, wherein the supplementary robots are carried within the storage unit and transported to a target area by the vehicle, and wherein the supplementary robots are recharged using the high-powered energy storage devices in the storage unit and diagnosed, debugged, and repaired using the computing system.

8. The mobile security robot of claim 1, wherein the robot control module, in communication with the electric motors in a drive subsystem of the vehicle, is configured to control speed of the vehicle using pulse-width modulation technology with regenerative braking.

9. The mobile security robot of claim 1, further comprising a support frame constituted by at least two triangle-poles disposed behind the human-sized mannequin on the vehicle, wherein the support frame is configured to support the human-sized mannequin and preclude the mobile security robot from being overturned and damaged due to a low center of gravity design of the mobile security robot.

10. The mobile security robot of claim 9, wherein the loudspeakers and the flashing light devices are disposed on a top side of the support frame above the human-sized mannequin.

11. The mobile security robot of claim 1, further comprising a plurality of user interface devices operably coupled to the computing system and configured to facilitate auditory and visual communication with humans in the patrol area, wherein the plurality of user interface devices comprises:
speakers configured to communicate with humans in the patrol area; and
one or more display panels connected to a front side of the vehicle for facilitating communication between the humans in the patrol area and control stations.

12. The mobile security robot of claim 1, wherein the computing system further comprises a communication module operably coupled to the at least one processor and to a plurality of supplementary robots and control stations via a cloud server, wherein the communication module is configured to upload and download data streams for processing, storage, and communications.

13. The mobile security robot of claim 1, wherein one or more of the computer program instructions, when executed by the at least one processor, cause the at least one processor to process audio data from the sensor data to interpret human speech and respond to verbal requests of the humans in the patrol area by executing voice recognition and natural language processing algorithms.

14. The mobile security robot of claim 1, wherein one or more of the computer program instructions, when executed by the at least one processor, cause the at least one processor to process image data from the sensor data to:
detect and identify a plurality of environmental objects in the patrol area using positioning algorithms, point cloud libraries, and one or more of the sensors;
facilitate navigation of the vehicle one of away from and toward the detected environmental objects;
detect a fire using the image data in combination with temperature data received from temperature sensors operating with cameras on the human-sized mannequin;
detect and digitize human poses in the image data using pose artificial intelligence (AI) analysis for identifying suspicious humans and irregular activities in the patrol area; and
perform advanced object tracking using computer vision algorithms.

15. The mobile security robot of claim 14, wherein one or more of the computer program instructions, when executed by the at least one processor, cause the at least one processor to process audio data from the sensor data to follow-up with the identified suspicious humans and the irregular activities in the patrol area using generative artificial intelligence along with the audio data received from microphone arrays mounted on the human-sized mannequin.

16. The mobile security robot of claim 1, wherein the plurality of tasks comprises:
shooting a colored fluid towards unlawful elements;
holding a striking tool to break barriers for inspection;
providing shields for protection from bullets and shrapnel;
offloading supplementary robots to a target patrol area to perform another one or more of the plurality of tasks; and
holding a water hose to one of extinguish a fire and solder metals in a shipyard.

17. The mobile security robot of claim 1, wherein the computing system further comprises a battery and power management module operably coupled to the at least one processor and configured to provide a sustained power source to the mobile security robot and manage power consumption based on task priority.

18. The mobile security robot of claim 1 configured to transform itself into another physical machine using one or more of the actuators to perform supplementary functions for protection, safety, and defence.

19. The mobile security robot of claim 1, wherein the artificial intelligence models comprise a large language model, a local large multimodal model, a cloud-based large multimodal model, and a deep neural network model.

20. The mobile security robot of claim 1, wherein the vehicle is one of an autonomous electric vehicle and a piston-operated vehicle, and wherein the vehicle is about 5 feet in length and about 4 feet in width, equipped with 21-inch tires.
